(19) United States
(12) Patent Application Publication
(10) Pub. No.: US 2015/0371146 A1
(43) Pub. Date: Dec. 24, 2015

(54) SYSTEM FOR REAL-TIME PROBABLISTIC RESOURCE MANAGEMENT

(71) Applicants: Jarrell D. Collier, Sherman Oaks, CA (US); Michael P. Davenport, Camarillo, CA (US); H.K. John Armenian, Sherman Oaks, CA (US)

(72) Inventors: Jarrell D. Collier, Sherman Oaks, CA (US); Michael P. Davenport, Camarillo, CA (US); H.K. John Armenian, Sherman Oaks, CA (US)

(73) Assignee: TECHFINITY, INC., Sherman Oaks, CA (US)

(21) Appl. No.: 13/539,075

(22) Filed: Jun. 29, 2012

Related U.S. Application Data
(63) Continuation of application No. 12/534,085, filed on Jul. 31, 2009, now abandoned.
(60) Provisional application No. 61/085,336, filed on Jul. 31, 2008.

(51) Int. Cl. G06N 7/00

(52) U.S. Cl. CPC G06N 7/005

(57) ABSTRACT

A system providing a real-time probabilistic prediction mechanism is described herein that is adapted to the address probabilistic implementations. The described mechanism provides a better balance between the tradeoffs of accuracy versus computational resources than the prior art, which makes it suitable for real-time applications, and in some cases offers a simpler path to implementation as well. In one exemplary approach, the real-time probabilistic prediction mechanism is implemented as a system for real-time resource management.

### CLAIM OF PRIORITY UNDER 35 U.S.C. §119

The present application for patent claims priority to Provisional Application No. 61/085,336 entitled “SYSTEM FOR REAL-TIME PROBABLISTIC RESOURCE MANAGEMENT”, filed Jul. 31, 2008, and assigned to the assignee hereof and hereby expressly incorporated by reference herein.

### BACKGROUND

I. Field

The following disclosure relates generally to resource deployment and planning in defense and security applications based on real-time probabilistic predictions for future events and conditions and, more particularly, to a system for real-time probabilistic resource management.

II. Background

In security and defense applications there are at least two primary functions that require probabilistic prediction. One primary function is an analysis of the probability that an object to be intercepted can be successfully intercepted using the deployment of a selected defensive resource. For example, there may be multiple defensive resources that can be deployed to intercept the object to be intercepted. Each can be evaluated on its own to determine the probability of a successful intercept. In addition, combinations of thereof can be evaluated as well.

The second primary function that requires probabilistic prediction is the evaluation of a threat, such as an object to be evaluated, to determine the nature of the threat. For example, part of the determination of the nature of the threat is the potential damage the object to be evaluated may cause to a threatened asset. In defense applications such as missile defense it is possible to learn more about the nature of the threat, especially in the discrimination process: sometimes it is possible to estimate the size of the various objects deployed from a threat missile, or even to obtain a radar image of the threat, and to estimate how it is spinning or tumbling and other kinematic behavior. All these determinations would provide various evaluations of the object.

The solutions to addressing these two functions take on different forms depending upon the source of the uncertainty in each function. In one instance, for systems that operate in real-time where, for example, information is gathered about a real, ongoing situation and processed as it is received; the primary source of uncertainty is generated by a sensor or sensor system that provides kinematic state information and possibly other types of information about an object to be evaluated. For example, sensors can be based on radar, infrared, image, acoustic, or anything that is capable of providing a measurement from which kinematic state information can be derived. The error can be due to electrical or mechanical noise generated by the sensor; discretization (approximation) error due to sampling, and, in some cases, distortion of the signal to do the medium through which the signal travels.

One important measure of performance of any system that operates under a real-time environment is the ability to effectively balance the tradeoff between accuracy of the solution and the processing resources required to obtain the solution. For example, due to the real-time nature of the situation under which the system has to operate, the system does not have unlimited processing time nor resources. Accuracy achieved at the cost of processing resources is undesirable in the system. On the opposite extreme, a complete sacrifice of accuracy is also undesirable as other down-stream resources will be wasted if the solution is not accurate.

Real-time probabilistic resource management is concerned with the problem of how to allocate limited resources in a near-optimal manner. In particular, the application described herein deals with the problem of tasking (or assigning) resources for particular use, and scheduling when the actions are to take place. Furthermore, this application relates to problems that deal specifically with the tasking of defensive resources that are capable of intercepting some threatening object.

The tasking and scheduling processes plan events that will occur in the future. As such, several key inputs to the processes are predictions or estimates about future events or conditions. These predictions include information such as the probabilities that a given defensive resource can successfully intercept the incoming threatening object within some window of opportunity, the probability of damage that may be inflicted by the threatening object if it is not intercepted, and the probability that a threatening object is lethal (its capacity of doing damage), all of which are described by some measure of uncertainty. All of these predictions contribute to the method by which the tasking and scheduling processes rank or score the tasking options. The determination of which tasking options are actually selected is controlled in part by the rankings, and in part by various constraints that limit the allocation of resources. These constraints can consist of things such as the availability of a particular resource at a particular time, some limit on how quickly available resources may be used up, or other limits that exclude regions of space or time within which the tasking and scheduling processes can plan to execute certain events. The constraints could also be based upon some user-provided input that is given during the planning process.

The resulting task plan and corresponding schedule that is developed in accordance with the rankings and constrains as described above provides an initial solution to the probabilistic resource management problem. It will be shown, however, that this initial solution is not guaranteed to be optimal or even near-optimal, so an iterative optimization step is typically applied to solve the problem. Many solution approaches exist for performing optimization of the initial solution, but most of them are computationally intensive and require significant computing time to arrive at an improved solution. These optimization approaches are not suitable for real-time applications that must be able to generate the initial task and scheduling plan in a period of time that is much shorter than the time window within which the system must execute the plan.

Consequently, it would be desirable to address one or more of the deficiencies described above.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject innovation relates to systems and/or methods that provides for management of battlespace resources including determining a probability of interception by an interceptor of an object to be intercepted; and allocating a set of resources based on the probability

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

FIG. 1 is a block diagram illustrating a system for real-time probabilistic resource management, configured in accordance with one desired approach.

FIG. 2 is a block diagram of a report generation system configured in accordance with one aspect of the disclosure;

FIG. 3 is a flow diagram of a real-time probabilistic resource management process configured in accordance with one aspect of the disclosure;

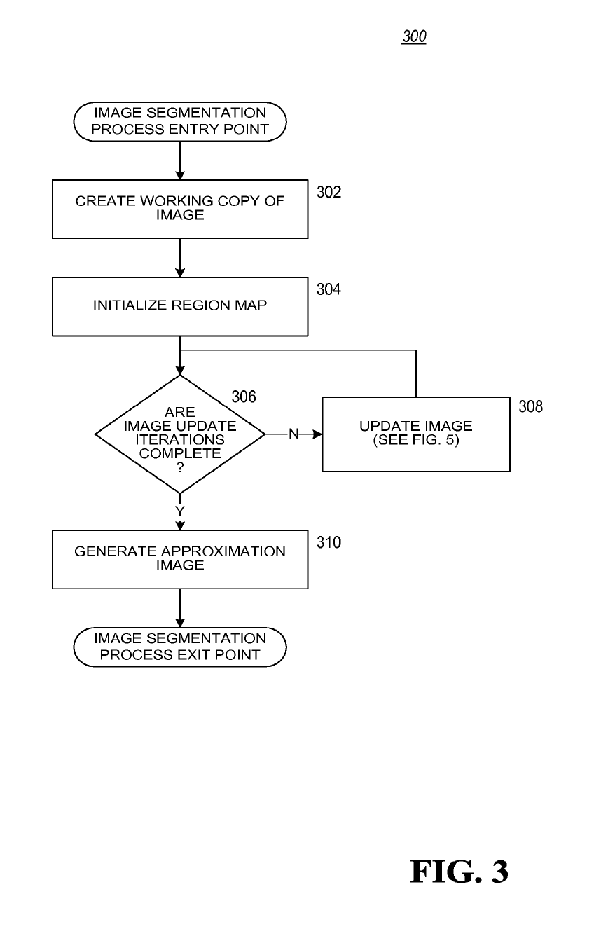

FIG. 4 is a

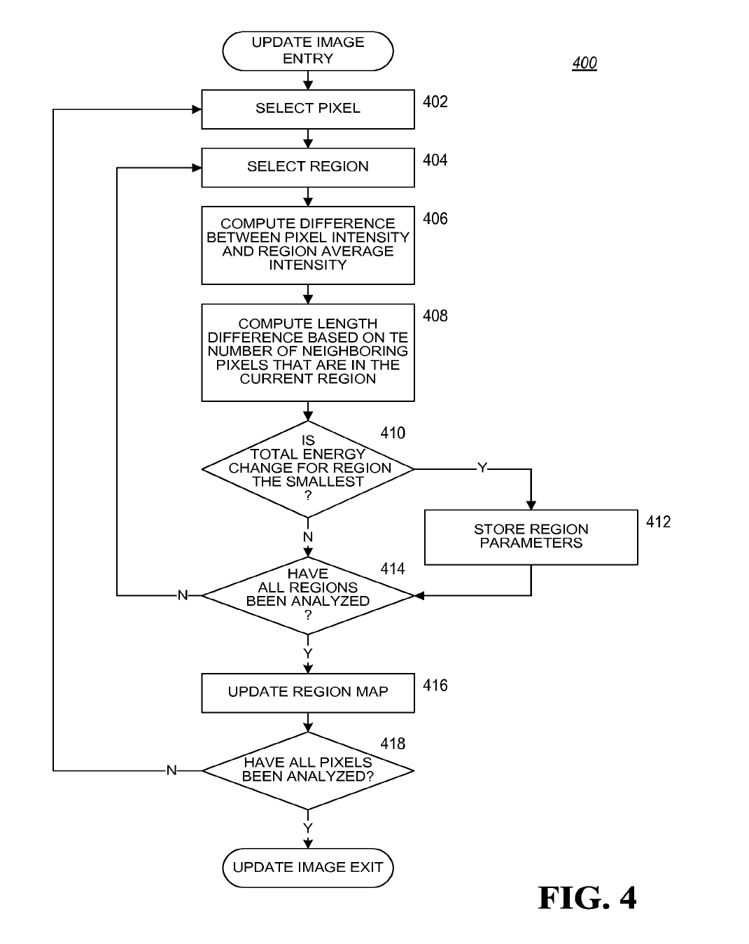

[symbol]

FIG. 5 is a block diagram of a target assignment structure configured in accordance with one aspect of the disclosure;

FIG. 6 is a block diagram of an engagement planner structure configured in accordance with one aspect of the disclosure;

FIG. 7 is a block diagram of the engagement planner structure inheritance structure configured in accordance with one aspect of the disclosure;

FIG. 8 is a block diagram of an asset value structure configured in accordance with one aspect of the disclosure;

FIG. 9 is a block diagram of a threat value structure configured in accordance with one aspect of the disclosure;

FIG. 10 is a block diagram of a threat forecast structure configured in accordance with one aspect of the disclosure;

FIG. 11 is a block diagram of a threat shooter pair structure configured in accordance with one aspect of the disclosure;

FIG. 12 is a block diagram of an engagement window structure configured in accordance with one aspect of the disclosure;

FIG. 13 is a block diagram of a threat asset pair structure configured in accordance with one aspect of the disclosure;

FIG. 14 is a block diagram of a threat lethality structure configured in accordance with one aspect of the disclosure;

FIG. 15 is a block diagram of an assignment matrix structure configured in accordance with one aspect of the disclosure;

FIG. 16 is a diagram of a four threat-shooter pair arrangement configured in accordance with one aspect of the disclosure;

FIG. 17 is a block diagram of a multiple cycle example in accordance with one aspect of the disclosure;

FIG. 18 is a block diagram of an engagement committer configured in accordance with one aspect of the disclosure;

FIG. 19 is a block diagram of an information evaluator structure configured in accordance with one aspect of the disclosure;

FIG. 20 is a block diagram of a battle preview structure configured in accordance with one aspect of the disclosure;

FIG. 21 is a block diagram of a battle transition structure configured in accordance with one aspect of the disclosure;

FIG. 22 is a block diagram of a battle state structure configured in accordance with one aspect of the disclosure;

FIG. 23 is a block diagram of an initialization report structure configured in accordance with one aspect of the disclosure;

FIG. 24 is a block diagram of a battlespace report structure configured in accordance with one aspect of the disclosure;

FIG. 25 is a block diagram of a threat evaluation report structure configured in accordance with one aspect of the disclosure;

FIG. 26 is a block diagram of a discrimination report structure configured in accordance with one aspect of the disclosure;

FIG. 27 is a block diagram of a launch report structure configured in accordance with one aspect of the disclosure;

FIG. 28 is a block diagram of a kill assessment structure configured in accordance with one aspect of the disclosure;

FIG. 29 is a diagram of a battlespace report sequence configured in accordance with one aspect of the disclosure;

FIG. 30 is a diagram of a treat evaluation report sequence configured in accordance with one aspect of the disclosure;

FIG. 31 is a diagram of a discrimination report sequence configured in accordance with one aspect of the disclosure;

FIG. 32 is a diagram of a commit engagement sequence configured in accordance with one aspect of the disclosure;

FIG. 33 is a diagram of a launch report sequence configured in accordance with one aspect of the disclosure;

FIG. 34 is a diagram of a kill assessment report sequence configured in accordance with one aspect of the disclosure; and

FIG. 35 is a block diagram of a computer system usable in the real-time object detection and interception system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

A system uses a real-time probabilistic prediction mechanism is described herein that is adapted to the address probabilistic battlespace analysis implementations. In one exemplary approach, the real-time probabilistic prediction mechanism is implemented in a system for real-time resource management.

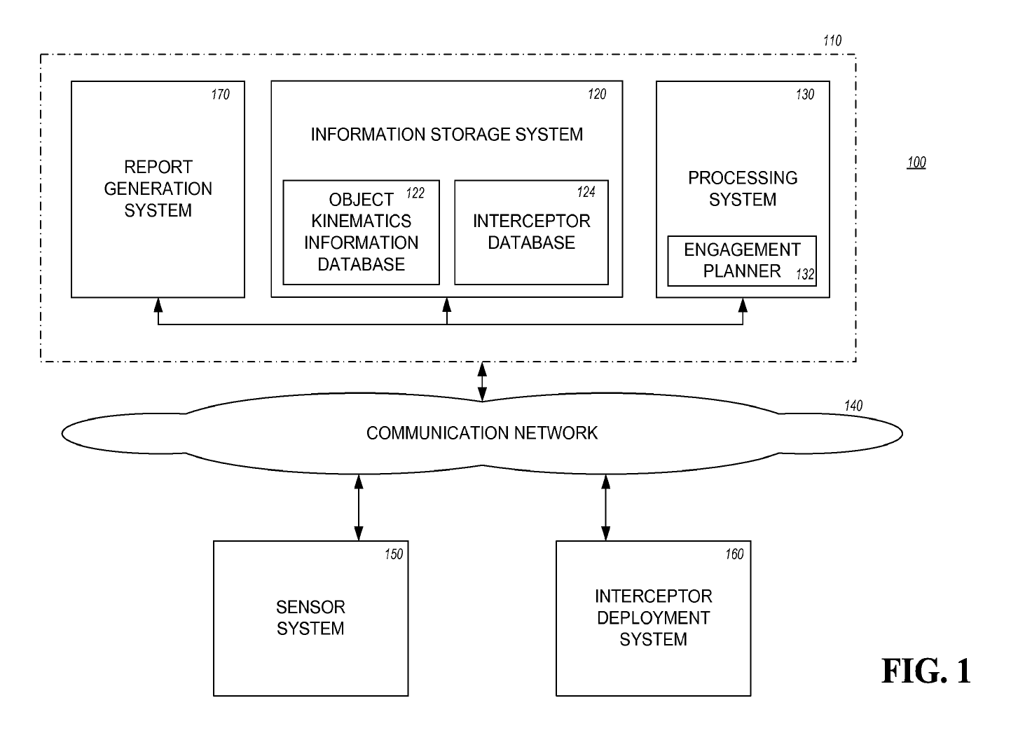

FIG. 1 illustrates a system diagram in which a real-time probabilistic resource management system 100 may be implemented in accordance with one aspect of the disclosure contained herein, including a server system 110 having a processing system 130 that includes an engagement planner 132. The processing system 130 is coupled to an information storage system 120 that includes an object kinematics information database 122 and an interceptor database 124. A sensor system 150 is coupled for communicating with the server system 110 through a communication network 140. Further, an interceptor deployment system 160 is coupled to the communication network 140 to be controlled by the server system 160. A report generation system 170 generates reports needed by the processing system 130 to provide the probabilistic resource management and planning as described herein.

The real-time probabilistic resource management system 100 implements a missile defense engagement planning (weapon resource allocation) system that is allocates, in real time or near real time, the use of missile defense resources to protect defended assets. In one aspect, primary missile defense resources, as illustrated in FIG. 1, are sensors—illustrated by the sensor system 150; and shooters—as illustrated by the interceptor deployment system 160. Sensors that may be used in the sensor system 150 include radar and/or infrared sensors. Typically, shooters in the interceptor deployment system 160 launch interceptors against attacking missiles, but other weapons may be used, such as a laser.

The engagement planner 132 interacts with other application software and modules on the processing system 130 and the information storage system 120 to perform the real-time resource management as described herein, including processing information received from the sensor system 150. The engagement planner 132 may access and present information from, as well as store information into, the information storage system 120. A user, using a client user interface (not shown to reduce complexity of description), interacts with the server system 110. Multiple server systems and clients, as well as other computer systems (not shown to reduce complexity of description) may also be coupled to the server system 110. Further, although the server system 110 is presented as two systems; with the processing system 130 residing on one system, and the information storage system 120 (including the object kinematics information database 122) residing on another system, the resource management functionality provided herein may be deployed using a single server system or may be spread over multiple systems.

In the illustrated example, the communications network 140 represents a variety of networks that may include one or more local area networks as well as wide area networks. The functionality provided by the information storage system 120, the processing system 130, as well as by any other computer systems necessary in the probabilistic system may be implemented using a computer system having the characteristics of the computer system described further herein. It should be noted, however, that the specific implementation of the computer system or systems used to describe the present system is not to be limiting unless otherwise specifically noted. For example, the functionality provided by the information storage system 120 and the processing system 130 may be combined in one computer system. Further, the functionality provided by the information storage system 120 and the processing system 130 may be distributed over several computer systems.

In a battle, an attacker will launch missiles against a plurality of defended assets protected by a missile defense system such as the real-time probabilistic resource management system 100. The missile defense system's sensors detect and track the various objects deployed from the attacking missiles, and attempt to discriminate the lethal objects from the non-lethal objects. The engagement planner 132 decides how and when to engage the threats. At each scheduled time, the engagement planner 132 commits an engagement by making an irrevocable decision to launch one or more interceptors from a shooter against a threat, in order to intercept the threat at a planned time and place. The sensors provide in-flight updates for each interceptor, and assess the results of each intercept attempt. The engagement planner 132 plans further engagements against any surviving threats.

In one aspect, the engagement planner 132 looks ahead minutes or even tens of minutes when planning engagements. It considers the value of waiting for improved sensor data, the probability of engagement success at the possible intercept times for the various threat-shooter pairs, the possible follow-up engagements for unsuccessful intercepts, the asset damage that could occur if a threat is not intercepted, the number of interceptors available at each shooter, and the possibility of future attacks. The primary inputs to the engagement planner are generated by the report generation system 170.

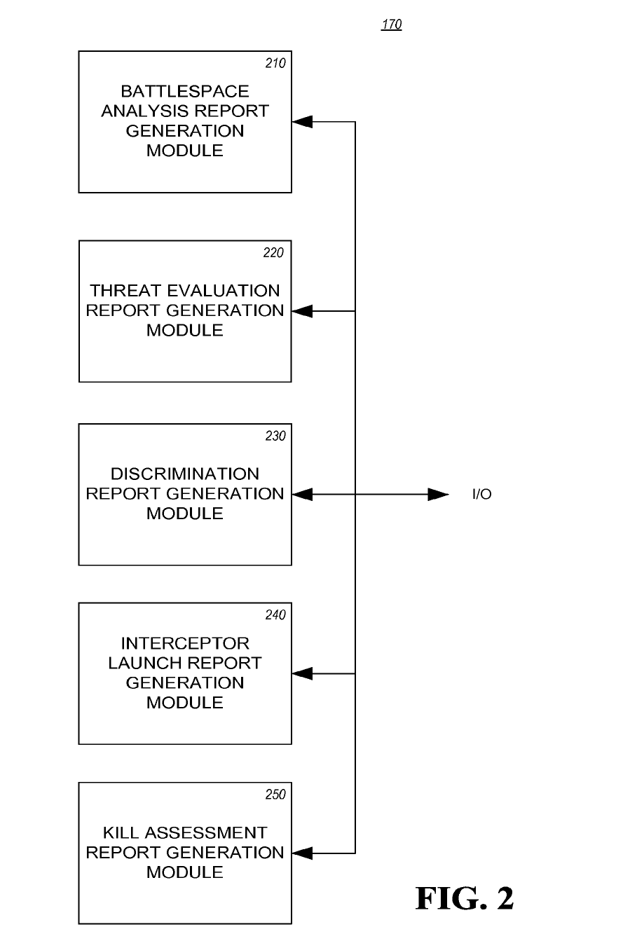

FIG. 2 illustrates the various modules that comprise the report generation system 170, including a battlespace analysis report generation module 210, a threat evaluation report generation module 220, a discrimination report generation module 230, interceptor launch report generation module 240, and a kill assessment report generation module 250.

A battlespace analysis report for a threat is essentially the single shot probability of kill as a function of intercept time, for each feasible threat-shooter pair. It is determined by the battlespace analysis module 210 on the basis of sensor track reports for the threat and knowledge of interceptor capabilities for the shooter. In another aspect, the battlespace report is a characterization of the probability distribution of the single shot probability of kill as a function of intercept time. Most of the engagement constraints are folded into the probability of kill; one example of which is a constraint on interceptor divert capability.

A threat evaluation report provides the expected damage for a threat, given that the threat is alive and lethal and that it is not intercepted, for each feasible threat-asset pair. It is determined by the threat evaluation module 220 on the basis of sensor track reports and knowledge of defended asset characteristics. In another aspect, a threat evaluation report indicates the probability distribution of surviving asset fraction.

A discrimination report for an object is the probability that the object is a lethal object. It is determined by the discrimination report generation module 230 on the basis of the various sensor tracking and feature reports.

An interceptor launch report tells the actual launch time of the various interceptors. It is generated by the interceptor launch report generation module 240 based on the fire direction of the shooter. It may also be generated by the shooter itself.

A kill assessment report describes the probability that an attempted intercept has succeeded in destroying the threat, or equivalently, the probability that the threat is still alive. It is determined based on a sensor function in the kill assessment report generation module 250.

The engagement planner 132 provides engagement plans. In this context, an engagement plan consists of a threat ID, a shooter ID, a number of interceptors, a launch time window, and an intercept time window. The actual interceptor launch times and the detailed launch parameters are determined by the fire direction function.

In one approach, the engagement planning problem is formulated as a constrained optimization solution in two parts. Initially, the engagement planning system is described for the case in which the number of interceptors assigned to each threat-shooter pair is assigned at the current time and will not be revised. That case arises, for example, when the outcomes of engagements with earlier interceptor launch times will not be known before the later interceptor launch times.

The following notation will be used:

Let nₜₕᵣₑₐₜₛ be the number of threats, nₛₕₒₒₜₑᵣₛ the number of shooters, and nₐₛₛₑₜₛ the number of defended assets.

Let p_{A} be a 1×nₜₕᵣₑₐₜₛ array of probabilities in which entry p_{A,I} is the probability that threat i is still alive at the current time despite any previous intercept attempts.

Let p_{L} be a 1×nₜₕᵣₑₐₜₛ array of probabilities in which entry is the probability that threat i is lethal.

Let P_{K} be an nₜₕᵣₑₐₜₛ×nₛₕₒₒₜₑᵣₛ array of probabilities in which entry p_{K,ij} is the single-shot probability of kill (successful intercept) for a shot against threat i from shooter j. Assume that 0≦p_{K,ij}<1 for all i and j.

Let p_{D} be an nₜₕᵣₑₐₜₛ×nₐₛₛₑₜₛ array of probabilities in which entry p_{D,ij} is the probability of asset damage for threat i against asset k, given that threat i is lethal and is not intercepted. Assume that 0≦p_{D,ij}<1 for all i and k.

Let vₜₕᵣₑₐₜ be a 1×nₜₕᵣₑₐₜₛ array of non-negative reals in which entry v_{threat,t} is the value of threat i.

Let vₐₛₛₑₜ be a 1×nₐₛₛₑₜₛ array of non-negative reals in which entry v_{asset,k} is the value of asset k.

Let x be an nₜₕᵣₑₐₜₛ×nₛₕₒₒₜₑᵣ array of non-negative integers in which entry xᵢⱼ is the number of interceptors assigned against threat i from shooter j.

Let N be a 1×nₛₕₒₒₜₑᵣₛ array of non-negative integers in which entry Nⱼ is the number of interceptors available at shooter j.

The two most important objective determinations are the threat-based and asset-based objective determinations. The threat-based objective determination is the expected surviving threat value when x is the number of interceptors assigned:

$$\begin{matrix}{f}_{threat} ( x ) = {\sum }_{i = 1}^{{n}_{threats}} {v}_{threat , i} P ( threat i is alive and lethal at ground impact \text{\textbar} x ) \\ = {\sum }_{i = 1}^{{n}_{threats}} {v}_{threat , i} {p}_{L , i} {p}_{A , i} {\prod }_{j = 1}^{{n}_{shooters}} {( 1 - {p}_{K , ij} )}^{{x}_{ij}}\end{matrix}$$

One reason to use this is when the specific assets from a grouping of target that are targeted by the specific threat cannot be identified. Another reason is that the threat-based objective determination is computationally less expensive than the asset-based objective determination.

The asset-based objective determination is the expected surviving asset value when x is the number of interceptors assigned:

$$\begin{matrix}{f}_{asset} ( x ) = {\sum }_{i = 1}^{{n}_{assets}} {v}_{asset , k} P ( asset k survives until the time horizon \text{\textbar} x ) \\ = {\sum }_{i = 1}^{{n}_{assets}} {v}_{asset , k} {\prod }_{j = 1}^{{n}_{threats}} ( 1 - {p}_{D , ik} {p}_{L , i} {p}_{A , i} {\prod }_{j = 1}^{{n}_{shooters}} {( 1 - {p}_{K , ij} )}^{{x}_{ij}} )\end{matrix}$$

One reason to use this objective determination is that it expresses more directly the goal of missile defense, which is to protect defended assets from missile attack.

In one aspect, the threat or asset values, as appropriate, are determined by a warfighter, also referred to as a weapon manager. The warfighter is the person directly responsible for configuring the missile defense weapon manager, and for authorizing the execution of its decisions. Typically, the warfighter will identify both point and area assets to be defended. A point asset is one that covers such a small area that it could be completely destroyed by a single attacking missile, such as a missile defense radar or interceptor launcher. An area asset is one that is large enough that it would be only partially destroyed by a single attacking missile, such as a city. In one aspect, the value the warfighter assigns to a defended asset is a non-negative real number that reflects the intrinsic value of the asset relative to the other defended assets, from the perspective of the goals of the missile defense system in the current battle, on a scale meaningful to the weapon manager. For example, the value of an area asset could be the area of the region covered by the asset, measured in square miles. A defended asset's value should not include an accounting for the importance of the asset for the outcome of the battle, because the weapon manager will account for that internally. For example, the value of a missile defense radar should not include an accounting for the effect of the possible loss of the radar on the outcome of the battle because the weapon manager will account internally for that effect. The weapon manager will assign more interceptors to defend an asset with higher value, other things being equal. Other things that may affect the weapon manager's decisions include the probability of damage to an asset by a missile if the missile is not intercepted, and the probability of success of a candidate intercept.

In one aspect, a primary goal is either to minimize the threat-based objective function or to maximize the asset-based objective determination, as specified by the weapon manager, by assigning the number of interceptors for each threat-shooter pair, subject to the following constraint on the number of interceptors from each shooter:

$${\sum }_{i = 1}^{{n}_{threats}} {x}_{ij} \leq {N}_{j} for j = 1 , … , {n}_{shooters}$$

That is, the number of interceptors assigned from shooter j can be no more than the number of interceptors available there.

Second, the engagement planning solution for the case in which the number of interceptors assigned to each threat-shooter pair may be revised in response to changing conditions. This case typically arises when the outcomes of engagements with earlier interceptor launch times will be known before the later interceptor launch times. Note that the preceding description can be regarded as a special case of this description.

In one aspect, the approach is formulated as a Markov decision process, using the following notation:

Let X(0=Xₜₕᵣₑₐₜ(t), Xₛₕₒₒₜₑᵣ(t), Xₐₛₛₑₜ(t)) be the battle state at time t, where the components are defined in the following way.

Xₜₕᵣₑₐₜ(t) is a 1×nₜₕᵣₑₐₜₛ array of non-negative reals in which entry X_{threat,i}(t) is the probability that threat i is still alive at time t.

Xₛₕₒₒₜₑᵣ (t) is a 1×nₛₕₒₒₜₑᵣₛ array of discrete probability distributions in which entry X_{shooter,j}(t) is the probability distribution of the interceptor inventory of shooter j at time t. X_{shooter,j}(t) itself is of the form (p₀, p₁, . . . , pₙ), where p₀ is the probability that the inventory is 0, p₁ is the probability that the inventory is 1, and so on.

Xₐₛₛₑₜ (t) is a 1×nₐₛₛₑₜₛ array of non-negative reals in which entry X_{asset,k} (t) is the probability that asset k has survived until time t.

Let T be the time horizon, the time when the last known threat missile reaches ground impact.

The times of interest are the times when an event occurs that can change the battle state. At a commit event, when interceptors from a shooter j are irrevocably committed against a threat, X_{shooter,j} changes. At an assess event, when kill assessment reports the outcome of an attempted intercept against a threat i, X_{threat,i} can change. At an impact event, when an unintercepted threat missile impacts the ground, X_{asset,k} can change, possibly for several defended assets k.

The Markov decision process consists of the sequence of battle states at the event times determined by the current tentative engagement plans, from the initial time to the time horizon. The engagement plans are chosen in order to optimize either the threat-based objective function or the asset-based objective function at the time horizon. The battle state is propagated from one event time to the next, starting at the initial time and ending at the time horizon, by applying a transition probability to the battle state at the preceding event time. The transition probability at an event time depends on the nature of the event.

Either objective determination can be evaluated using the battle state at the time horizon. For the threat-based objective determination,

$$\begin{matrix}{f}_{threat} ( x ) = {\sum }_{i = 1}^{{n}_{threats}} {v}_{threat , i} P ( thrcat i is alive and lethal at ground impact \text{\textbar} x ) \\ = {\sum }_{i = 1}^{{n}_{threats}} {v}_{threat , i} {p}_{L , i} {X}_{threat , i} ( T )\end{matrix}$$

For the asset-based objective determination,

$$\begin{matrix}{f}_{asset} ( x ) = {\sum }_{k = 1}^{{n}_{assets}} {v}_{asset , k} P ( asset k survives until the time horizon \text{\textbar} x ) \\ = {\sum }_{k = 1}^{{n}_{assets}} {v}_{asset , k} {X}_{asset , k} ( T )\end{matrix}$$

The expressions given explicitly in the preceding case are summarized in the battle state X(T) in this case.

Previous approaches are those provided by conventional engagement planning and scheduling (EPS) approaches. These can be seen in approaches developed for current ballistic missile defense systems such as Terminal High Altitude Area Defense (THAAD) and Ground-Based Midcourse Defense (GMD). Some of the assumptions for these conventional EPS approaches are not appropriate for current missile defense systems. In particular, the assumed numbers of threats and shooters are orders of magnitude larger than those faced by current systems. Thus, the models and approaches incorporating simplifications and approximations were mainly appropriate for handling such large numbers.

The current system identifies the characteristics of EPS problem formulations before formulating a sequence of problems of increasing complexity based on categories defined by those characteristics, and investigates approaches for some of the problems, starting with the simplest. Efficient solutions for the simpler problems serves as building blocks for solutions to the more complex problems. The EPS problem classifications include

An EPS problem is target-based if the objective function is the threat-based objective function, and asset-based if it is the asset-based objective function.
The EPS problem is closed-loop if the problem formulation allows the use of kill assessment and interceptor failure information; otherwise, it is open-loop.
The EPS problem is perfectly observed if the sensors are modeled as providing perfect kill assessment and discrimination information; otherwise, it is partially observed.

The problem is nuclear if threats are allowed to use salvage fuzing; otherwise, it is non-nuclear. Presumably, all threats are considered to carry nuclear weapons in many EPS problems.
The problem is sensor-constrained if the availability of sensor resources is considered to be a constraint; otherwise, it is sensor-unconstrained.

The study formulated the following sequence of problems of increasing complexity, based on these characteristics:
Open-loop, target-based.
Open-loop, asset-based.
Closed-loop, perfectly observed, target-based.
Closed-loop, partially observed, target-based.
Closed-loop, partially observed, asset-based.
Nuclear, closed-loop, partially observed, asset-based.
Sensor-constrained, nuclear, closed-loop, partially observed, asset-based.

The study used solutions for the simpler problems as building blocks for solutions to the more complex problems. The resulting approaches were structured as multilevel approaches, with exact linear integer programming approaches at the lowest level and heuristics and approximations at the upper levels. Understandably, the study reported more success on the simpler problems than on the more complex problems.

In the simplest scenario, the study investigated special cases of the open-loop target-based problem which could be solved exactly in polynomial time by linear integer programming approaches, especially by linear network flow approaches. Next the study investigated approximate approaches for the general open-loop target-based problem, based on these linear integer programming approaches. For example, the maximum marginal return approach (described below) was proposed in this context. The study continued by investigating approaches for the open-loop asset-based problem using approximations based on solutions to the open-loop target-based problem, followed by further approximations for versions of the remaining problems.

Out of all of these approaches, the maximum marginal return (MMR) approach emerged as the conventional approach to engagement planning. It uses the first formulation of the engagement planning problem described above. Suppose that the objective function is the asset-based objective function. The marginal return for a threat-shooter pair is the change in objective function value that would result from assigning one more interceptor to the pair. The MMR approach iteratively updates the marginal returns and assigns one more interceptor to the pair with largest marginal return, until no more assignments are possible.

MMR is a coordinate ascent optimization approach. On each step it adds an assignment that causes the largest possible increase in the objective function's value. The following pseudocode is written for maximization. In another aspect, for minimization use the negative of the objective function and marginal return.

function x = MMROptimization( )

x = zeros(nThreat, nShooter);
for j = 1:nShooter

if (N(j) > 0)

for i = 1:nThreat

| | |
|---|---|
| compute r(i, j); | //marginal return |

end

else

for i = 1:nThreat

r(i, j) = 0;

end

end

end
done = false;
while (not done)

if (all r(i, j) == 0)

done = true;

else

find (i′, j′) such that r(i′, j′) == max r(i, j);
x(i′, j′) = x(i′, j′) + 1;
N(j′) = N(j′) − 1;
for j = 1:nShooter

if (N(j) > 0)

for i = 1:nThreat

compute r(i, j); //marginal return

end

else

for i = 1:nThreat

r(i, j) = 0;

end

end

end

end

end
return x;

end

The MMR approach is ordinarily used to assign interceptors only to those threat-shooter pairs for which the threat is currently unengaged, without explicitly considering the effect of possible follow-on engagements or future threats. Sometimes other approaches are applied to improve particular features of the solution with respect to future threats, such as shooter inventory balancing.

Further, MMR is ordinarily constrained by the number of interceptors currently available at each shooter and by a firing doctrine. The firing doctrine might be something like shoot-look-salvo; that is, first assign one interceptor to a threat and then, if it fails, assign a prescribed number of interceptors.

The original THAAD engagement planning approach uses the first formulation of the problem, but uses heuristics to extend to apply to the situation described by the second formulation of the problem. The approach is based on the MMR approach, with several refinements, as shown in the following pseudocode:

function PlanEngagements( )

initialize variables for engagement planning;

// assign launch sites: first pass
assign launch sites to minimize leakage value;
modify launch site assignments to minimize launch site

imbalance;

// assign launch sites: second pass
assign launch sites to minimize leakage value;
reserve interceptors for later rungs;
modify launch site assignments to minimize launch site

imbalance;

// assign sensors
assign sensors to minimize sensor occupancy imbalance;

end

The approach assigns interceptors to unengaged threats on the current rung by launch site in order to minimize the threat-based objective function. There are several assignment constraints:
Interceptors are assigned only to unengaged threats.
At most one interceptor is assigned to a threat that is not on the last rung.
most a fixed number of interceptors are assigned to a threat that is on the last rung.
An assignment must have at least a fixed marginal return.
No more assignments are made after the expected surviving threat value is less than a fixed fraction of the total threat value.

The approach has two assignment passes. On the first pass, the approach makes as many assignments as possible by MMR and then modifies them to minimize launch site imbalance. Since the modification step could make more assignments possible, the approach makes a second pass which is just like the first, except that it includes an additional step to reserve interceptors for later rungs. On each assignment pass the approach applies the MMR approach three times:
Assign first interceptor to threats on the last rung.
Assign first (and only) interceptor to threats not on the last rung.
Assign remaining interceptors to threats on the last rung.

Finally the approach assigns a sensor to support each engagement, attempting to assign the sensors in a way that minimizes the occupancy imbalance between sensors.

When the engagement planning problem is formulated as a Markov decision process, some version of the dynamic programming approach is the conventional approach. In principle, dynamic programming would be an ideal method for solving the engagement planning problem but it is often computationally infeasible. Neuro-dynamic programming is an approximate version of dynamic programming which promises to make it a feasible method by training a neural network offline to approximate the cost-to-go function.

Conventional scheduling is based on rung-related heuristics. A rung is a shoot-look-shoot opportunity. The number of rungs for a threat is the number of interceptor salvos it is possible to launch against the threat, with salvos separated by the reception of kill assessment reports. One such heuristic is to choose the earliest launch time for each rung. The idea is that shoot-look-shoot type scheduling conserves interceptors, and choosing the earliest launch time for each rung maximizes the number of salvos launched.

Current systems emphasize linear network flow approaches that are reasonable for problems of certain sizes, but it is inappropriate for the much sparser problems now being considered. In particular, linear approaches can only approximate nonlinear objective functions such as the threat-based and asset-based objective functions.

The MMR approach is fast, and often produces good assignments, but it can fail to find optimal assignments, even for a simple objective function, for two reasons. First, it always chooses a threat-shooter pair that gives the greatest increase in objective function value. Second, it always assigns one interceptor at a time. MMR never explores an alternate sequence of assignments, never backtracks, never assigns two or more interceptors at a time, and never assigns fractions of interceptors.

For example, consider the following engagement planning problem. The objective function is the threat-based objective function, which is to be minimized. There are two threats and two shooters. Both threats are alive and lethal with probability 1. The other problem data is shown in the following tables:

Single-shot probability of kill

| | Shooter 1 | Shooter 2 |
|---|---|---|
| Threat 1 | 0.8 | 0.3 |
| Threat 2 | 0.7 | 0.6 |

Threat value

| | |
|---|---|
| Threat 1 | 100 |
| Threat 2 | 30 |

Interceptor inventory

| Shooter 1 | Shooter 2 |
|---|---|
| 2 | 2 |

MMR assignments

| | Shooter 1 | Shooter 2 |
|---|---|---|
| Threat 1 | 1 | 1 |
| Threat 2 | 1 | 1 |

Optimal assignments

| | Shooter 1 | Shooter 2 |
|---|---|---|
| Threat 1 | 2 | 0 |
| Threat 2 | 0 | 2 |

In this example, the value of the threat-based objective function is 17.6 for the MMR assignments and 8.8 for the optimal assignments. In terms of the objective function value, the optimal assignments are twice as good as the MMR assignments.

As mentioned above, the dynamic programming approach is infeasible in the real-time missile defense setting, except for small cases.

Unfortunately, it appears that the neuro-dynamic programming approach requires a known fixed probability of kill in order to perform the offline training of the neural network, but the probability of kill is not at all a fixed value. In fact, the probability of kill is a function of time that is only known in real time.

The problem with conventional scheduling is that we might miss the best shot, especially if there is little slack in the rungs. For example, suppose there is one threat, one shooter, two rungs, no slack, and two shots available. Suppose that if we take one shot per rung we must accept small probability of kill on both shots, but otherwise we can take a two-shot salvo with high probability of kill. In this case, it would be better to ignore the rungs.

The approach adopted by the engagement planner 132 uses the Markov decision process formulation of the engagement planning solution. This formulation is supported by a data structure that maintains a sequential probabilistic preview of the evolving state of the battle, given the committed and planned engagements. This approach allows possible future engagements to compete with current engagements for missile defense resources, allowing for the probability that those future engagements will occur.

The approach implemented by the engagement planner 132 projects ahead beyond the time horizon, which is the time when all threats in flight have reached ground impact. This capability is supported by a data structure that maintains a probabilistic forecast of possible future threats. Possible future threats are imagined to be detected at an unspecified time beyond the time horizon, and they are included in the competition for interceptors as virtual threats, along with the real threats. The probability that a virtual threat is alive is the probability that such a threat will appear at some future time. This approach avoids the need for a predetermined firing doctrine and interceptor reserve policy, and automatically balances shooter inventories.

In one aspect, the engagement planner 132 determines an initial solution quickly and then improves the solution using available time and computing resources. The initial solution is generated using the MMR approach. At each step of the MMR approach, there is a competition for the next assignment between the best engagements for all threat-shooter pairs, both real and virtual.

The new invention uses randomized approaches to improve the initial solution. This approach was inspired by the success of randomized approaches in solving other NP-hard problems. For example, randomized approaches have been developed for some NP-hard problems that provably find a near-optimal solution with arbitrarily high probability in polynomial time. For other problems randomized approaches have been shown experimentally to outperform known deterministic approaches.

The new invention includes several approach options:
Single-rung MMR.
Single-rung MMR with improvement by randomized rounding.
Single-rung MMR with improvement by stochastic search.
Multiple-rung MMR.
Multiple-rung MMR with improvement by randomized rounding.
Multiple-rung MMR with improvement by stochastic search.

The single-rung options are appropriate for the situation in which no shoot-look-shoot opportunities will be available, as for short-range missile defense, while the multiple-rung options are appropriate for the opposite situation.

The approaches with improvement by randomized rounding use a version of

MMR that allows fractional assignments; the improvement approach searches the integer-valued solutions near the real-valued initial solution. The approaches with improvement by stochastic search explore a neighborhood of the initial integer-valued solution; neighboring solutions can differ by assignments to multiple threat-shooter pairs.

This approach focuses on the last two options.

The following sections describe the structure and approaches of the various aspects of the disclosure. Here is a guide to some of the names and abbreviations used in this section:

Target Assignment (TA): is the weapon resource manager.

Defense Planner (DP): is responsible for preplanning, in particular for non-real-time weapon resource laydown.

Threat Evaluation (TE): calculates predicted probability of damage to defended assets if a threat missile in flight is not intercepted

Battlespace Analysis (BA): calculates predicted single-shot probability of kill for possible intercepts against a threat missile in flight. It also determines possible interceptor launch times and the corresponding intercept times.

Discrimination (DC): determines the probability of lethality for a threat missile in flight.

Fire Control (FC): provides the interface between the weapon manager and the shooters.

Kill Assessment: calculates the probability that a threat missile in flight has survived an attempted intercept.

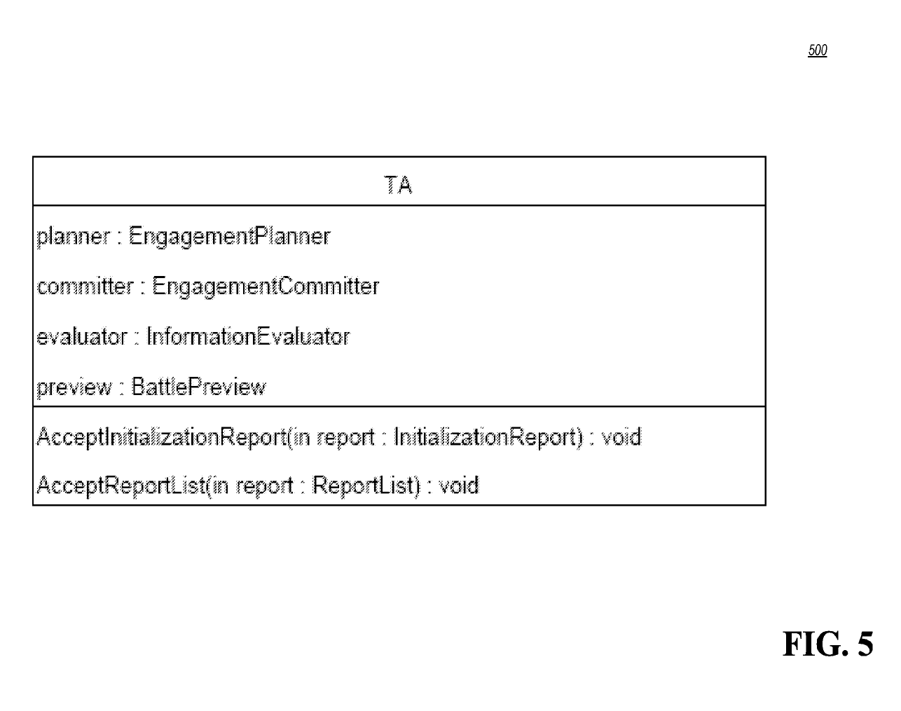

FIG. 5 illustrates a Target Assignment (TA) structure 500 that includes an engagement planner, an engagement committer, an information evaluator, and a battle preview. The engagement planner plans engagements, the engagement committer commits engagements, and the information evaluator determines the value of information. The battle preview contains planned and committed future events. Each of the elements will be described herein.

### Engagement Planner

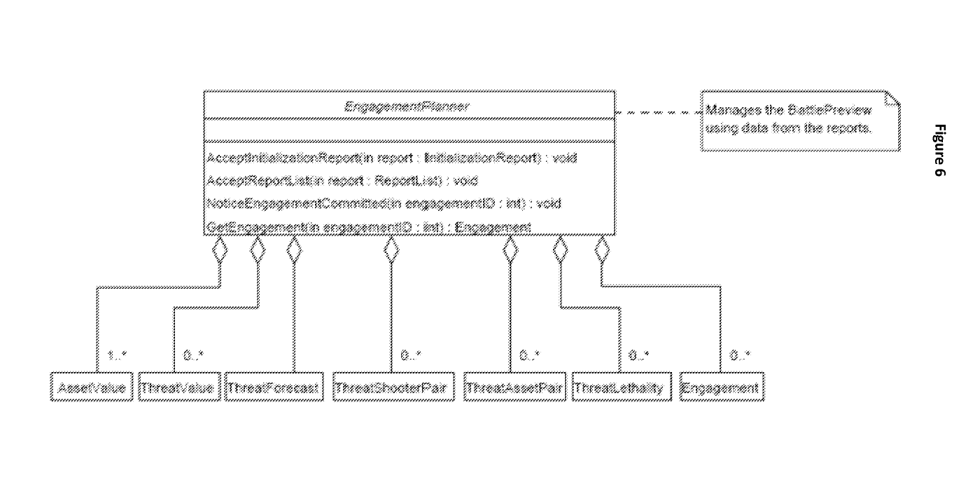

FIG. 6 illustrates an engagement planner structure 600 for the engagement planner. The engagement planner structure 600 has a list of asset values, a list of threat values, possibly a threat forecast, a list of threat-shooter pairs, a list of threat-asset pairs, a list of threat lethalities, and a list of engagements.

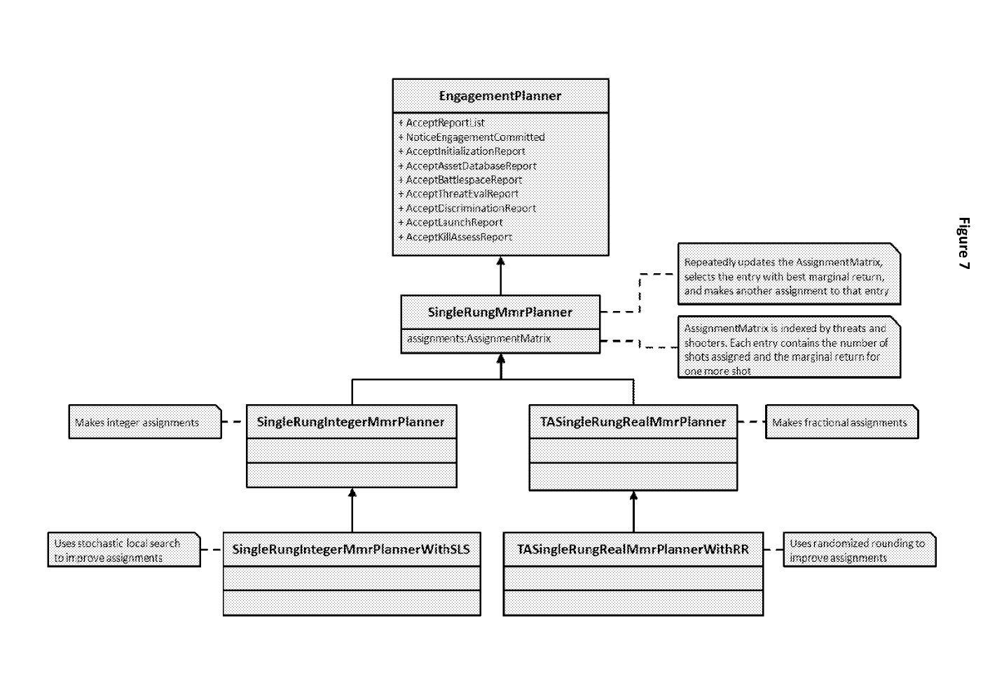

The engagement planner class is a virtual class. Part of its inheritance structure is shown in FIG. 7. The single rung MMR planner class is also a virtual class. All of its descendants look ahead only as far as the current rung. A single rung integer MMR planner makes integer assignments, while a single rung real MMR planner makes fractional assignments. A single rung integer MMR planner with stochastic local search constructs an initial set of assignments just like a single rung integer MMR planner, and then uses stochastic local search to find an improved set of assignments. A single rung real MMR planner with randomized rounding constructs an initial set of assignments just like a single rung real MMR planner, then uses randomized rounding to find a good set of integer assignments.

In addition, the engagement planner class has a tree of descendants derived from a multiple rung MMR planner class that mirrors the tree of descendants derived from a single rung MMR planner class pictured here. The descendants of a multiple rung MMR planner look ahead potentially to the end of the battle.

### Asset Value

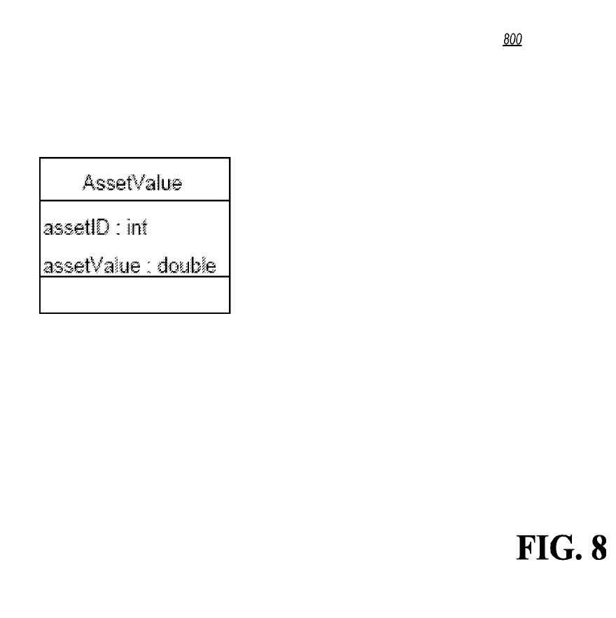

The asset value list has an entry for each defended asset, including the shooters, indicating the value of each asset. FIG. 8 illustrates an asset value structure 800.

### Threat Value

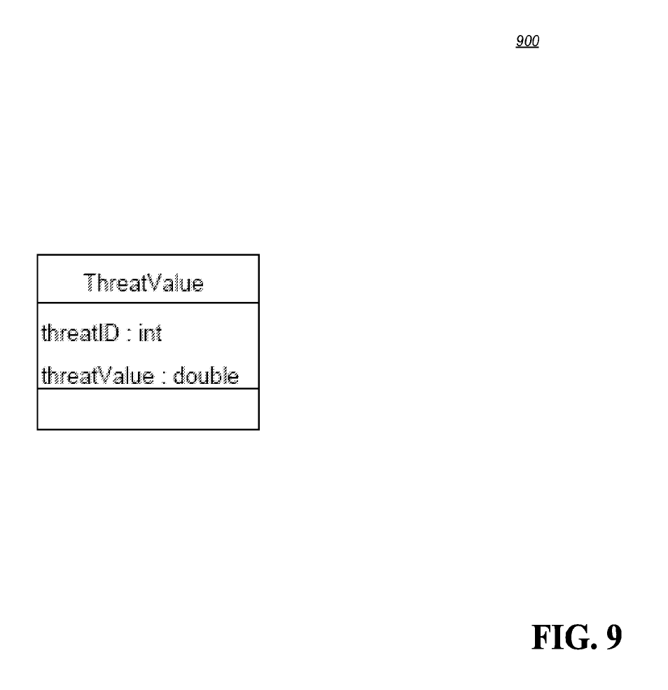

The threat value list has an entry for each threat in flight, indicating the value of each threat. A threat value structure 900 is illustrated in FIG. 9.

### Threat Forecast

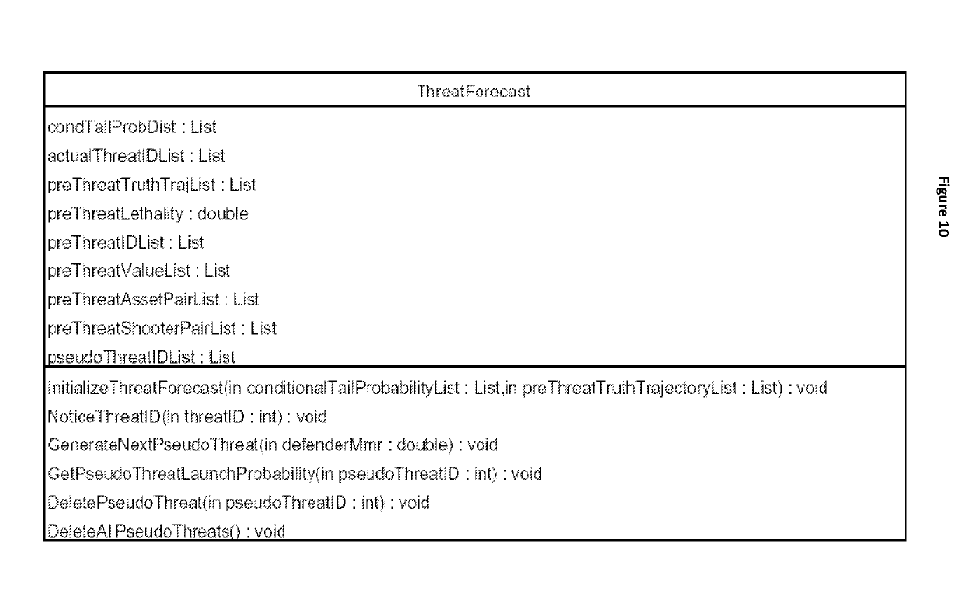

The threat forecast maintains a list of the threat IDs of threats that have actually been launched and information about the threats that are likely to be launched during the battle. Shown in FIG. 10 is a threat forecast structure 1000.

The conditional tail probability list is a list of probabilities pₙ for n=0, 1, 2, . . . , where pₙ is the conditional probability that at least one more threat will be launched by the end of the battle, given that n threats have actually been launched so far. The user can specify pₙ for n=0, 1, 2, . . . , nₘₐₓ any desired nₘₐₓ≧0. For n>nₘₐₓ, it is automatically assumed that pₙ=pₘₐₓ. The specified values must satisfy 0≦pₙ≦1, and 0≦pₙ_{ₘₐₓ}<1.

The threat forecast internally maintains information about a collection of pre-threats. The pre-threat truth trajectory list is a representative list of possible threat trajectories for the battle. The trajectories can be obtained from the defense planner, for example. For convenience, the threat forecast has a list of pre-threat IDs, one for each trajectory. In addition, the threat forecast maintains information for each pre-threat just like the planner maintains for actual threats, including pre-threat lethality, pre-threat value, pre-threat-shooter pairs, and pre-threat-asset pairs. Pre-threat lethality is the probability that the pre-threat is a lethal object, which is 1.0 for all pre-threats. Pre-threat value and pre-threat-asset pairs are obtained by invoking threat evaluation, and pre-threat-shooter pairs are obtained by invoking (non-probabilistic) battlespace analysis, as if pre-threats were actual threats.

A pre-threat is the threat forecast's internal version of a pseudo-threat. A pre-threat can be thought of as a template for pseudo-threats. The threat forecast can generate multiple pseudo-threats from a single pre-threat. Pseudo-threats participate in the interceptor assignment process, effectively as if they were actual threats.

Whenever the planner asks the threat forecast to generate a new pseudo-threat, the threat forecast chooses a worst case pre-threat (with respect to the current preview) and generates the pseudo-threat's lethality, threat value, threat-shooter pairs, and threat-asset pairs by copying the corresponding pre-threat information. These values go into the corresponding planner lists, so the planner can assign interceptors to pseudo-threats as if they were real threats. One distinction is that for an actual threat, the planner initially sets the probability that the threat is alive to 1.0; but for a pseudo-threat, the planner initially sets it to the pseudo-threat's launch probability, which is determined from the conditional tail probability list.

### Threat-Shooter Pair

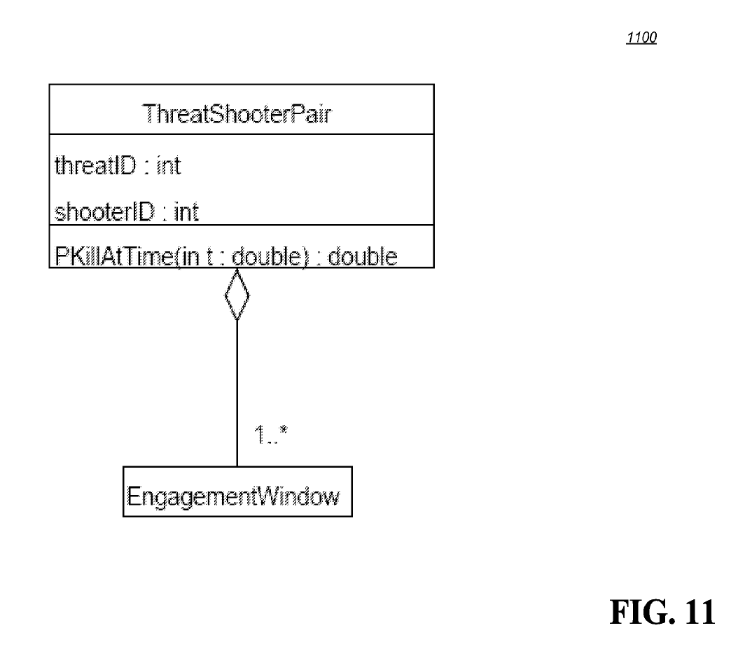

The threat-shooter pair list has an entry for each pair consisting of a threat in flight and a shooter that has feasible shots at the threat. Each threat-shooter pair has a list of the engagement windows for the pair. FIG. 11 illustrates a threat shooter pair structure 1100.

### Engagement Window

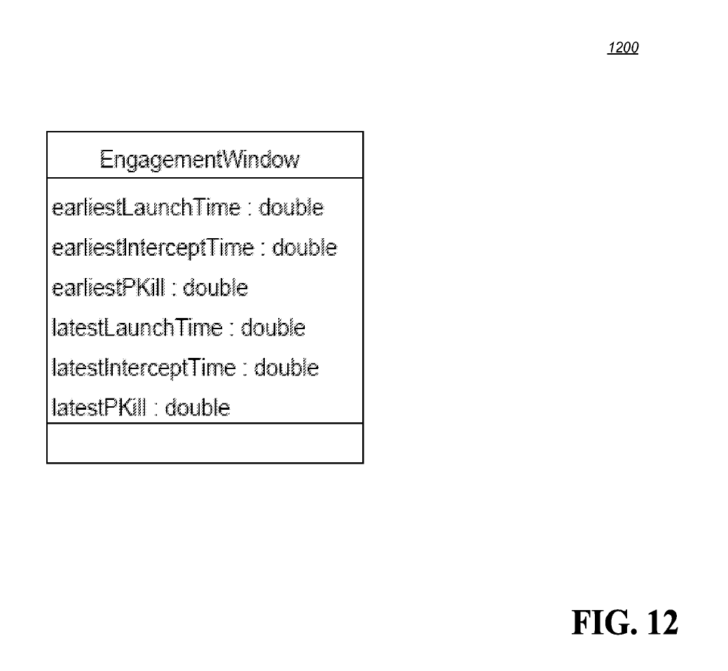

An engagement window is determined by earliest and latest intercept times and the corresponding launch times and single shot probabilities of kill. FIG. 12 illustrates an engagement window structure 1200.

### Threat-Asset Pair

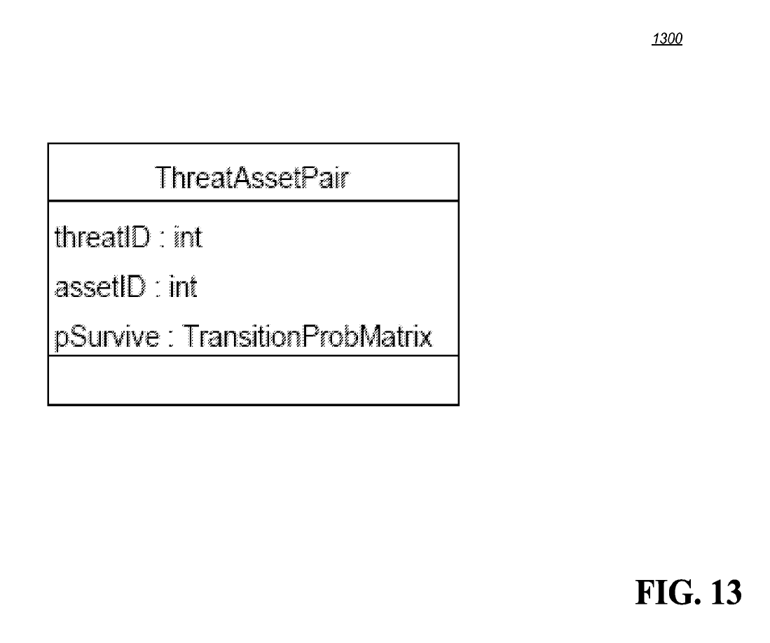

The threat-asset pair list has an entry for each pair consisting of a threat in flight and an asset that could be damaged by the threat if it survives until ground impact. Each pair includes a transition probability matrix (or data sufficient to determine the matrix) for the resulting change in the probability distribution of the asset's surviving fraction. FIG. 13 illustrates a threat asset pair structure 1300.

### Threat Lethality

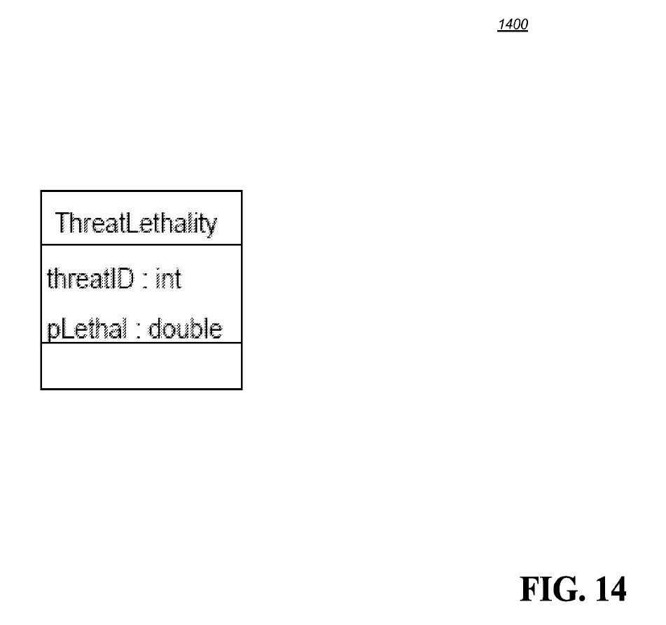

The list of threat lethalities has an entry for each threat in flight. Each threat lethality indicates the probability that the threat actually is lethal. A reentry vehicle is considered to be lethal. Decoys, penetration aids, and debris are not considered to be lethal. FIG. 14 illustrates a threat lethality structure 1400.

### Engagement

The engagement list has an entry for each engagement that is currently assigned, whether committed or not. Each engagement has the following fields: threat ID, shooter ID, number of interceptors, nominal commit time, nominal launch time, nominal intercept time, nominal assess time, engagement window, and is committed.

### Assignment Matrix

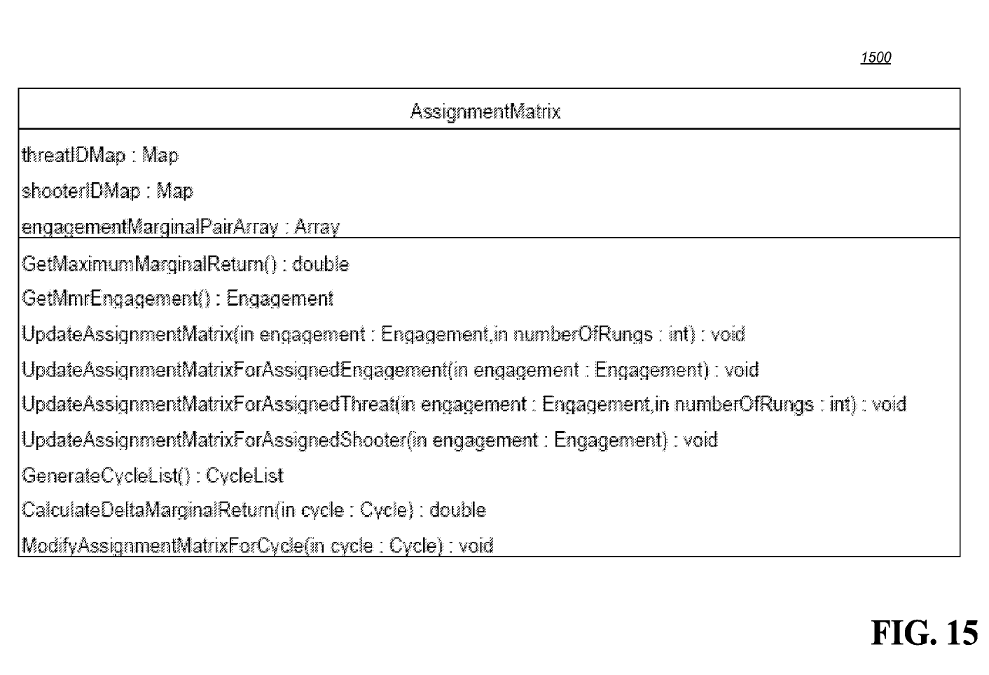

Every MMR planner uses an assignment matrix. An assignment matrix has a two-dimensional array of engagement-marginal pairs, a threat ID map, and a shooter ID map. The threat ID map associates each threat ID to an array row index. The shooter ID map associates each shooter ID to an array column index. An engagement-marginal pair has an engagement and the marginal return on the objective function for the engagement. An engagement-marginal pair is stored in the row and column determined by the engagement's threat ID and shooter ID. The engagement in an engagement-marginal pair could be empty; in that case, the marginal return is negative infinity. FIG. 15 illustrates an assignment matrix structure 1500.

The stochastic local search approach modifies the assignment matrix by changing assignments according to randomly generated cycles.

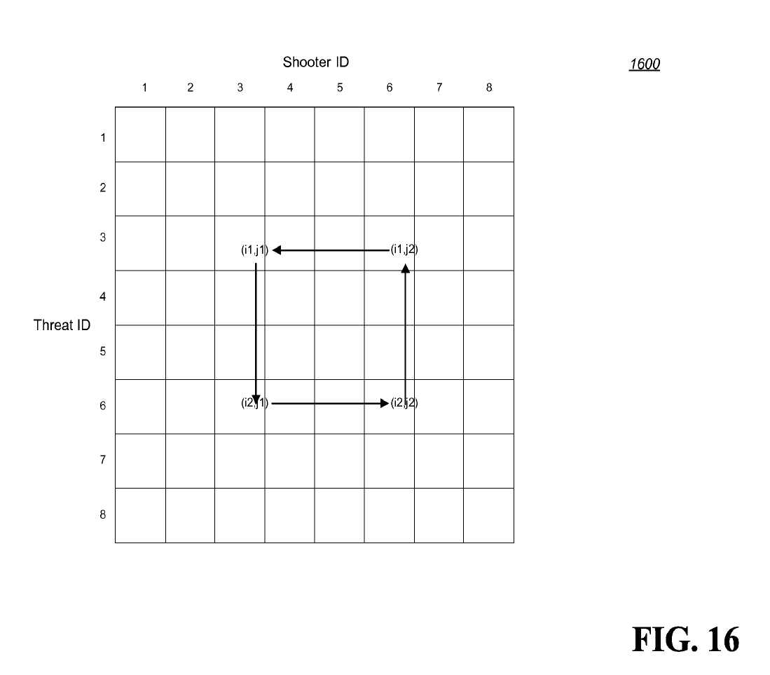

A cycle involves four threat-shooter pairs. FIG. 16 illustrates an arrangement of four threat-shooter pairs 1600. An interceptor assignment is transferred along each vertical arrow. For the cycle in the figure, one assignment is transferred from the threat-shooter pair in the upper left corner to the pair in the lower left corner. The pair in the upper left corner is called a from-pair and the pair in the lower left corner is called a to-pair. Another assignment is transferred from the threat-shooter pair in the lower right corner to the pair in the upper right corner. The pair in the lower right corner is a from-pair and the pair in the upper right corner is a to-pair. A from-pair must have at least one interceptor assigned and a to-pair must have a potential shot.

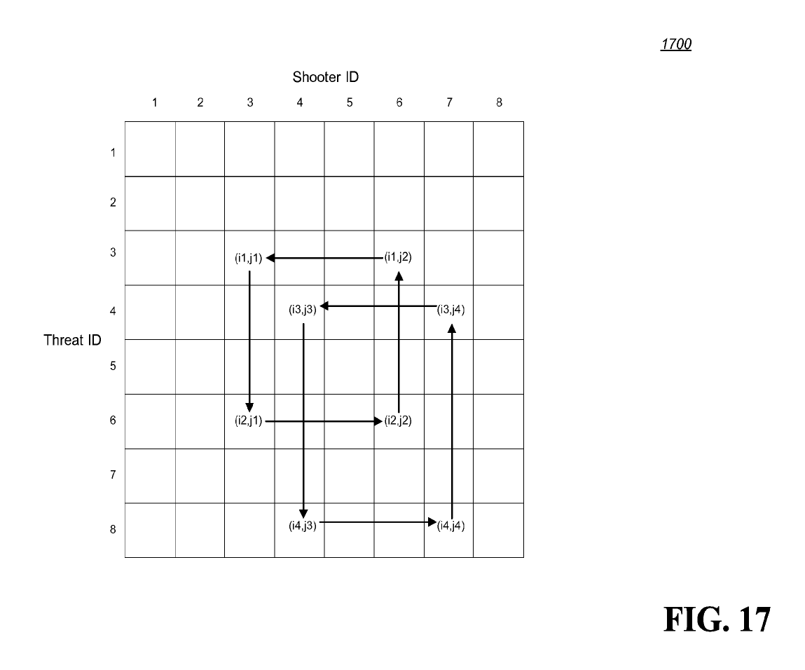

Multiple cycles can be applied at a time. FIG. 17 illustrates a multiple cycle example 1700.

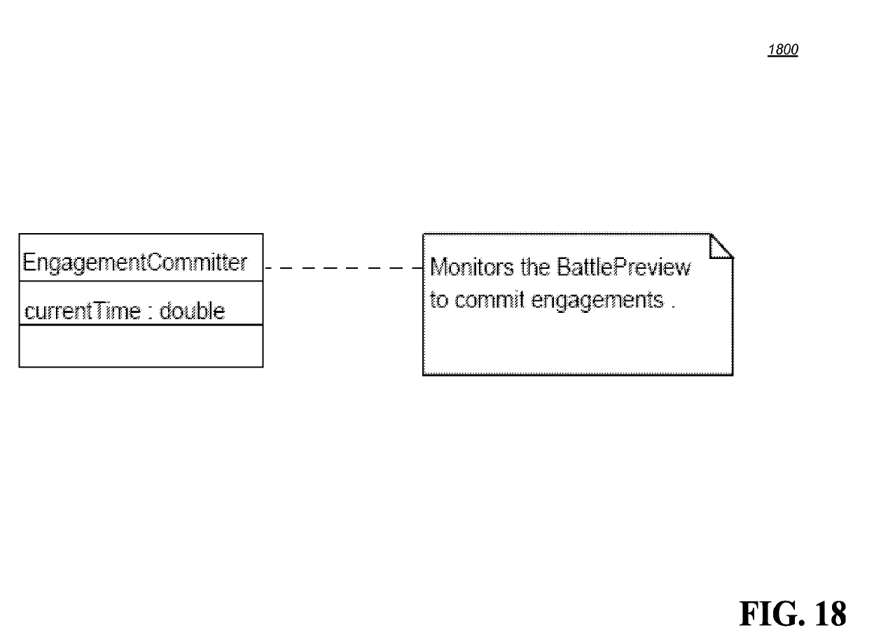

The committer monitors the preview and commits engagements when the current time reaches their commit times. For this purpose the committer only needs to know the current time, so it has the simple structure shown in FIG. 18, which illustrates an engagement committer 1800.

### Information Evaluator

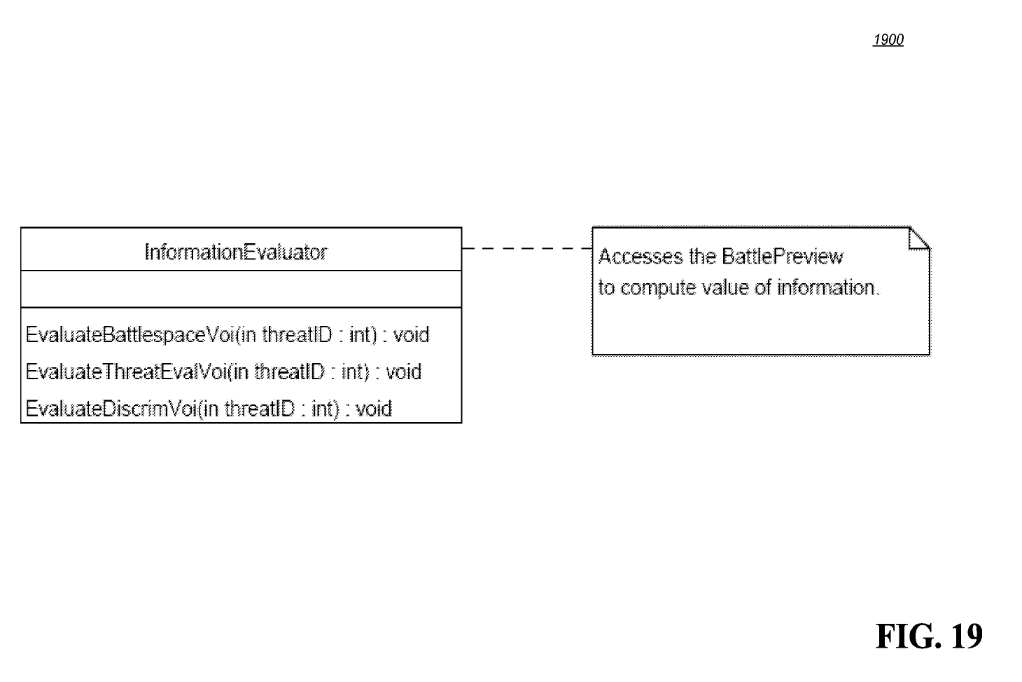

The information evaluator accesses the preview to determine the value of information by estimating the rate of improvement in the planner's objective function that would result from improving the information from battlespace analysis, threat evaluation, or discrimination. Its structure has not yet been determined completely, as shown in FIG. 19, which illustrates an information evaluator 1900.

### Battle Preview

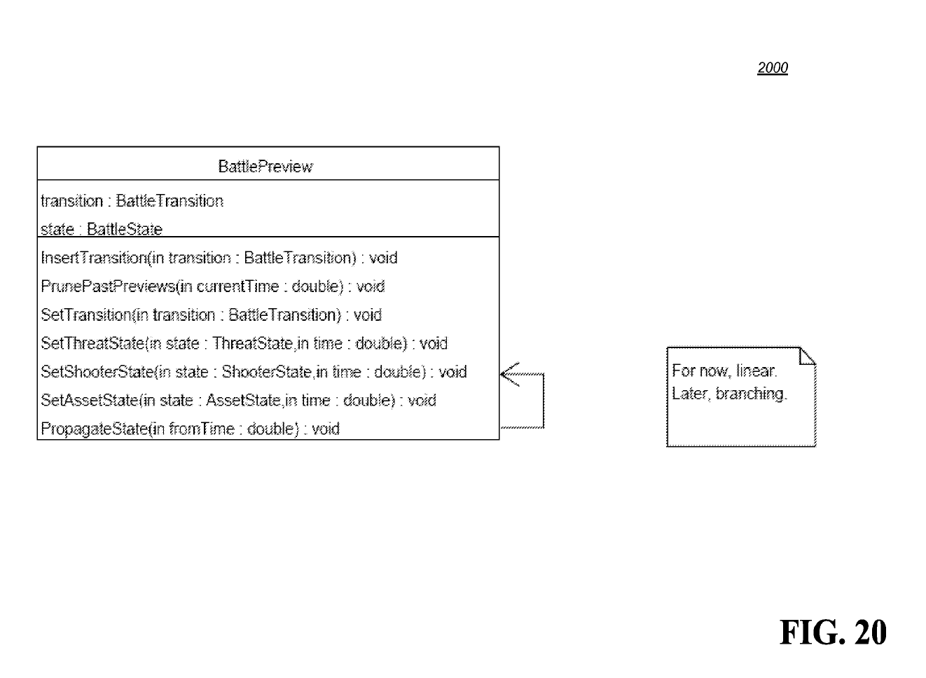

A battle preview is a dynamic recursive data structure that contains the current planned and predicted course of the battle. Its structure is shown in FIG. 20, which illustrates a battle preview structure 2000.

Each battle preview node includes a battle transition and a battle state, and has zero or more children. In the initial versions the preview will have a linear structure, but later it will have a tree structure.

### Battle Transition

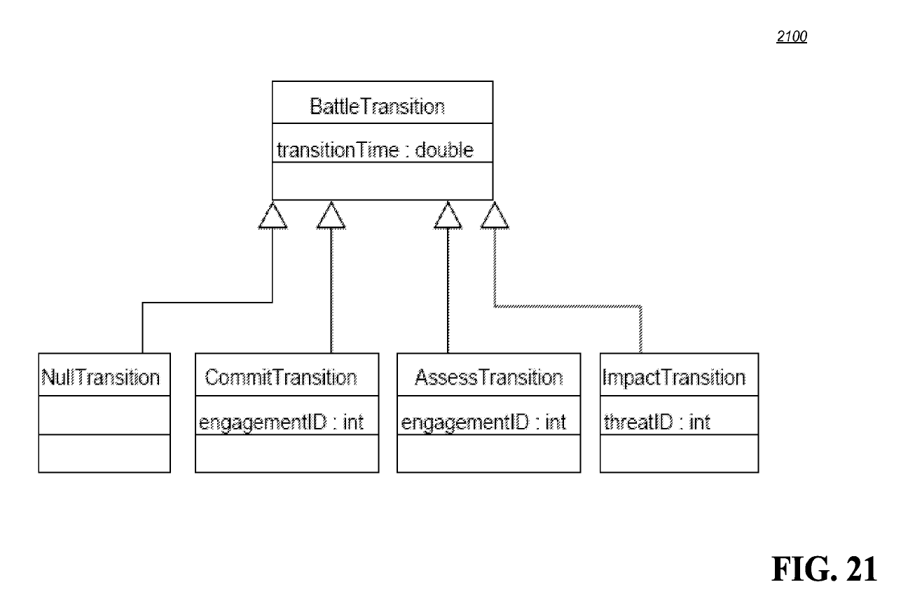

A battle transition determines a change in state. Its structure is shown in FIG. 21, which illustrates a battle transition structure 2100.

There are four kinds of transitions: null, commit, assess, and impact. Every transition has a transition time and possibly other information.

A null transition is simply a placeholder. It has no other data.

A commit transition specifies the commit event for an engagement. The transition time is the engagement's commit time; specifically, the latest time the committer can commit the engagement. The transition includes (or points to) the engagement. The engagement's shooter's state changes at the commit time.

An assess transition specifies the kill assessment event for an engagement. The transition time is the kill assessment time for the engagement; specifically, the earliest time the planner should stop waiting for an assessment of the engagement. The transition includes (or points to) the engagement. The engagement's threat's state changes at the assess time.

An impact transition specifies a threat's impact time. The transition includes the threat ID. Asset states change at the impact time.

### Battle State

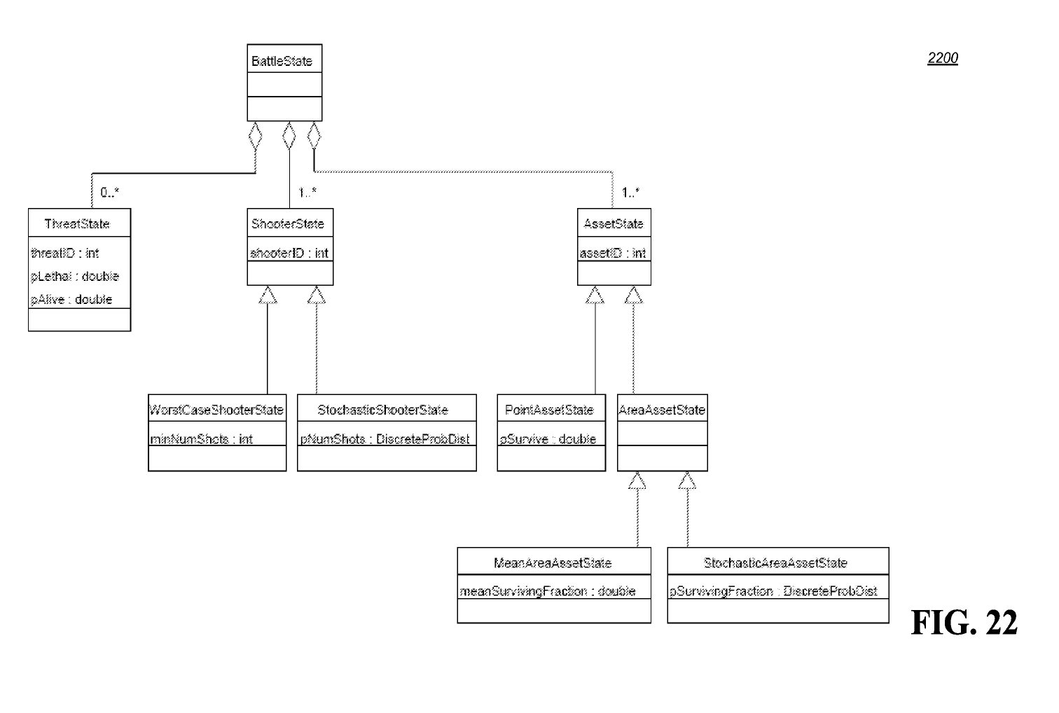

A battle state is the TA's model of the battle at the time immediately following a transition; specifically, at the time immediately following the transition in the same preview node. Its structure is shown in FIG. 22, which illustrates a battle state structure 2200.

The state has a threat state list, a shooter state list, and an asset state list.

The threat state list has an entry for each threat in flight at the time. A threat state includes the probability that the threat is lethal, given that it is alive, and the probability that the threat is alive at the time.

The shooter state list has an entry for each shooter. There are two kinds of shooter states, used by different planner approaches: worst case and stochastic. A worst case shooter state indicates the minimum number of shots available at the shooter at the time. A stochastic shooter state indicates the probability distribution of the number of shots available at the time.

The asset state list has an entry for each asset. There are two kinds of assets states: point and area. A point asset is an asset that can be regarded as having either survived or not survived. Its state includes the probability that it has survived until the time. An area asset is an asset that may have only a surviving fraction. There are two kinds of area asset states, used by different approaches: mean and stochastic. A mean area asset state includes the asset's expected surviving fraction. A stochastic area asset state includes a discrete approximation to the probability distribution of the asset's surviving fraction. The probability distribution indicates the probability of predetermined surviving fractions, from zero to one.

### Interfaces

TA has interfaces with Defense Planner (DP), Battlespace Analysis (BA),

Threat Evaluation (TE), Discrimination (DC), Fire Control (FC), Kill Assessment, and

Performance Analysis (PA).

### TA-DP Interface

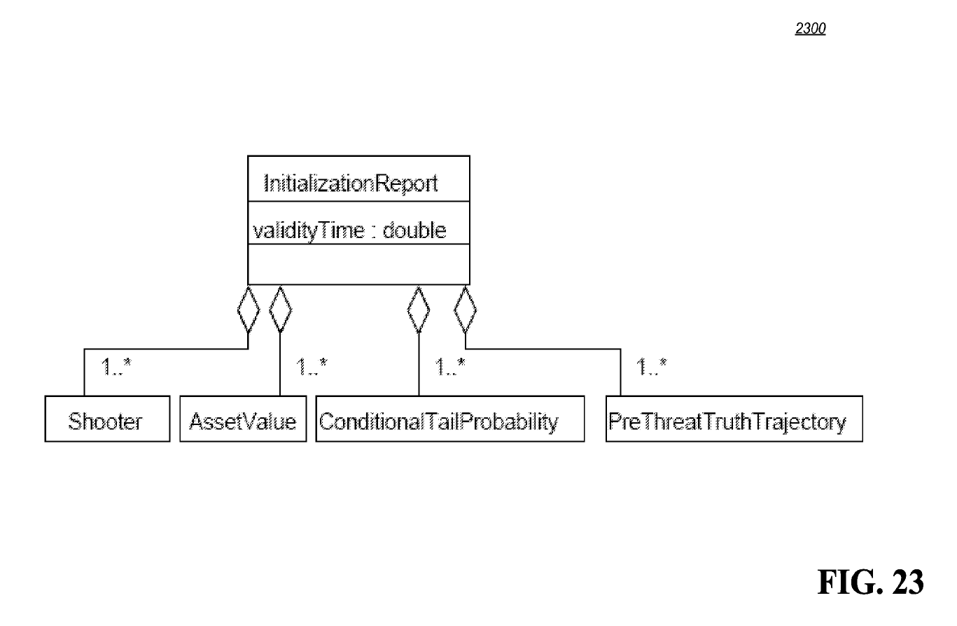

TA receives an initialization report from DP. The structure of the report is shown in FIG. 23, which illustrates an initialization report structure 2300.

The report contains a list of shooters, a list of assets, a list of conditional tail probabilities, and a list of pre-threat truth trajectories. The structure and meaning of a shooter, asset, conditional tail probability, and pre-threat truth trajectory are described herein.

### TA-BA Interface

TA receives data from BA and sends data to BA.

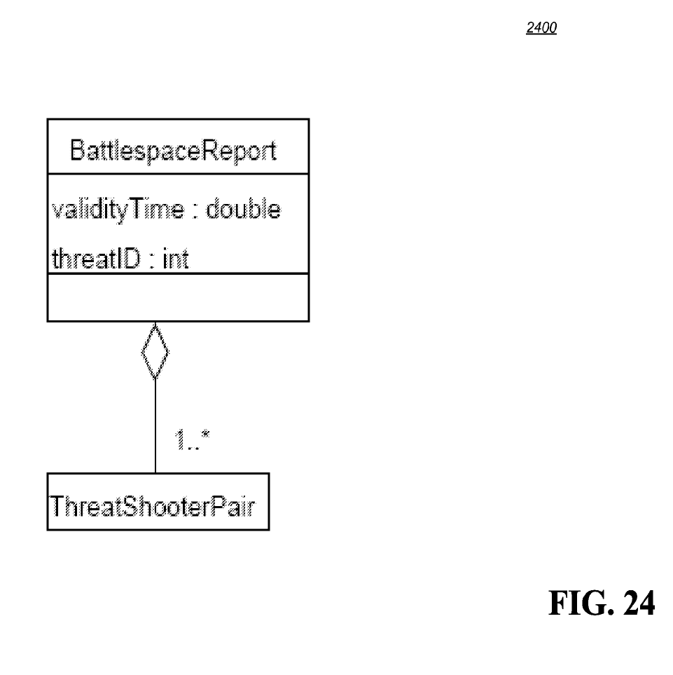

TA receives battlespace reports from BA. These reports may be bundled in a report list with other kinds of reports. The structure of a battlespace report is shown in FIG. 24, which illustrates a battlespace report 2400.

A battlespace report contains the threat ID and a list of threat-shooter pairs, which are described herein. A battlespace report's threat-shooter pairs contain all of the engagement windows for all of the feasible shooters for the given threat.

TA sends value of battlespace information reports to BA. The structure of these reports is to be determined.

In addition, TA obtains battlespace reports for pre-threats from BA.

### TA-TE Interface

TA receives data from TE and sends data to TE.

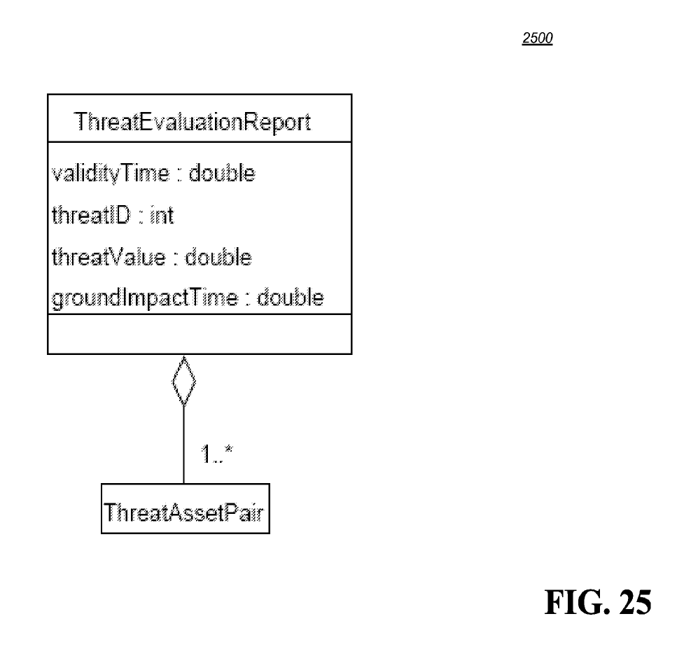

TA receives threat evaluation reports from TE. These reports may be bundled in a report list with other kinds of reports. A threat evaluation report contains the threat ID, threat value, threat ground impact time, and a list of threat-asset pairs, which are described herein. A threat evaluation report's threat-asset pairs include all of the threatened assets for a given threat. FIG. 25, illustrates a threat evaluation report 2500.

TA sends value of threat evaluation information reports to TE.

In addition, TA obtains threat evaluation reports for pre-threats from TE.

### TA-DC Interface

TA receives data from DC and sends data to DC.

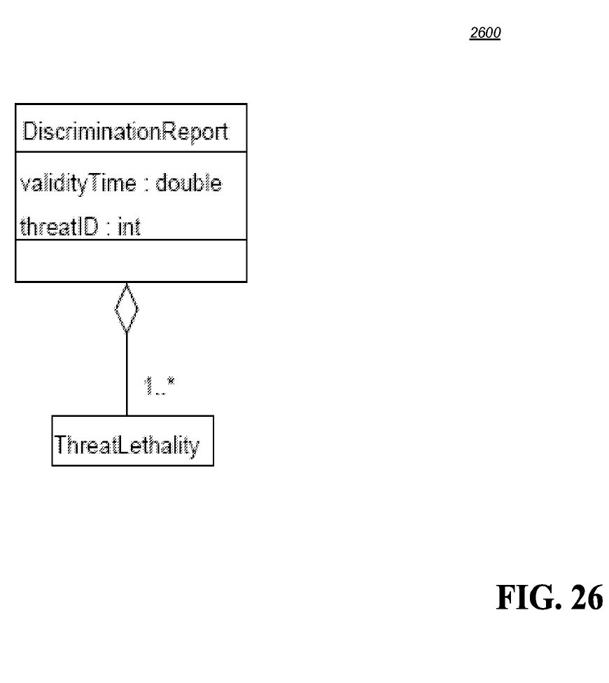

TA receives discrimination reports from DC. These reports may be bundled in a report list with other kinds of reports. The content of a discrimination report is shown in FIG. 26, which illustrates a discrimination report 2600

A discrimination report contains a list of threat lethalities, which are described herein.

TA sends value of discrimination information reports to DC. The structure of these reports is to be determined.

### TA-FC Interface

TA sends data to FC and receives data from FC.

TA irrevocably commits an engagement by sending it to FC. FC sends an engagement on to the appropriate shooter. The structure of an engagement is described herein.

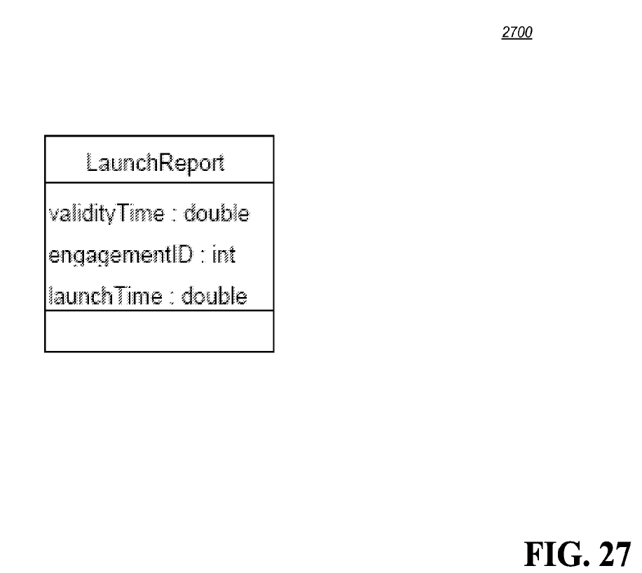

TA receives launch reports from FC when the shots in an engagement have been launched. These reports may be bundled in a report list with other kinds of reports. The structure of a launch report is shown in FIG. 27, which illustrates a launch report 2700.

### TA-KA Interface

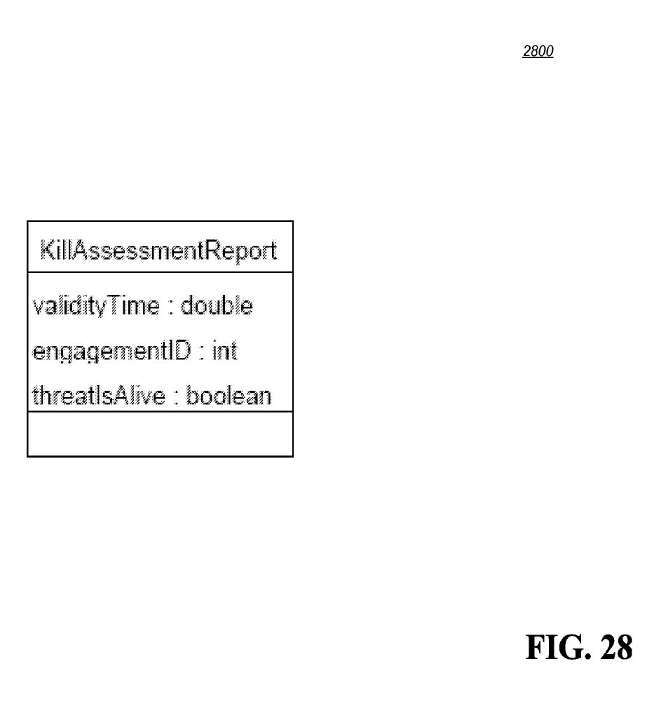

TA receives a kill assessment report from KA after an engagement has either succeeded or failed and KA has assessed the outcome. These reports may be bundled in a report list with other kinds of reports. Actually, the kill assessment report contains a probability, pAlive, rather than a boolean. FIG. 28 illustrates a kill assessment report structure 2800.

### Sequences

### Battlespace Report Sequence

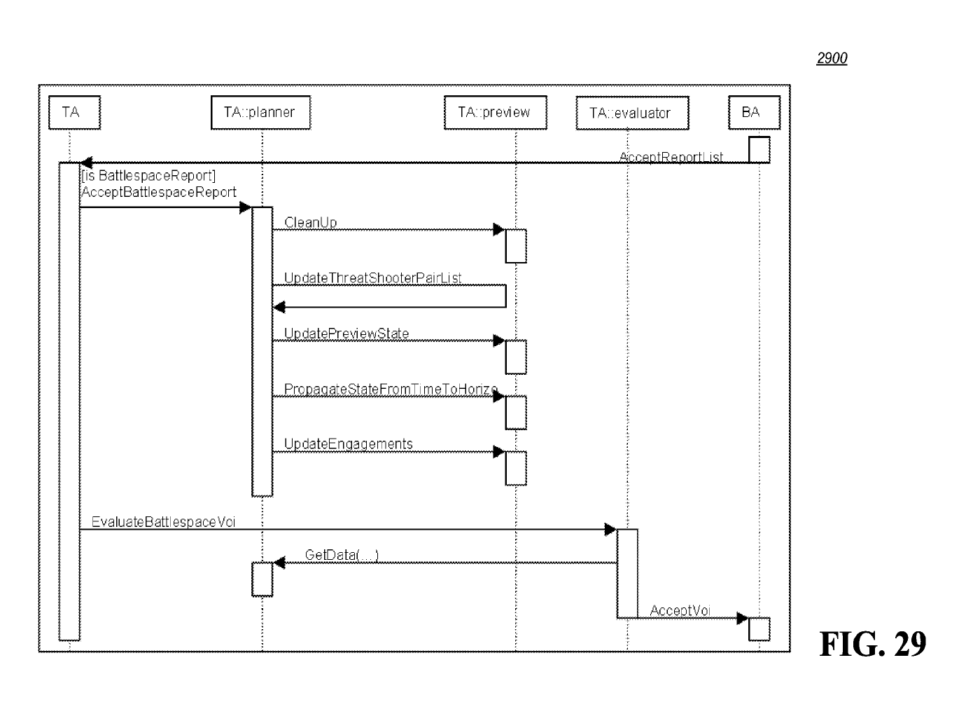

FIG. 29 illustrates a battlespace report sequence 2900. When TA accepts a battlespace report from BA, it passes the report on to the planner. The planner cleans up its internal data structures, updates the threat-shooter pair data, updates the preview state, propagates the preview state, and updates the engagements. Next, TA tells the evaluator to evaluate the battlespace value of information (VOI). The evaluator gets the data it needs from the planner, computes the battlespace VOI, and sends it to BA.

### Threat Evaluation Report Sequence

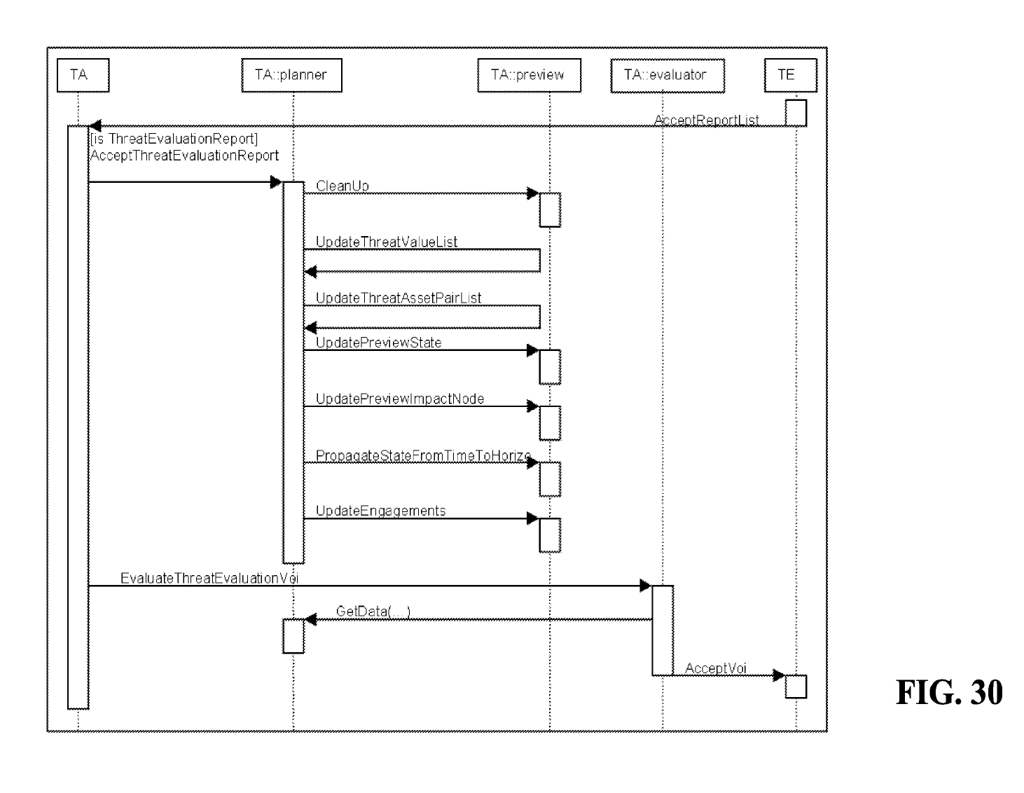

FIG. 30 illustrates a threat evaluation report sequence 3000. When TA accepts a threat evaluation report from TE, it passes the report on to the planner. The planner cleans up its internal data structures, updates the threat value list, updates the threat-asset pair data, updates the preview state, updates the preview's impact node for the threat, propagates the preview state, and updates the engagements. Next, TA tells the evaluator to evaluate the threat evaluation VOI The evaluator gets the data it needs from the planner, computes the threat evaluation VOI, and sends it to TE.

### Discrimination Report Sequence

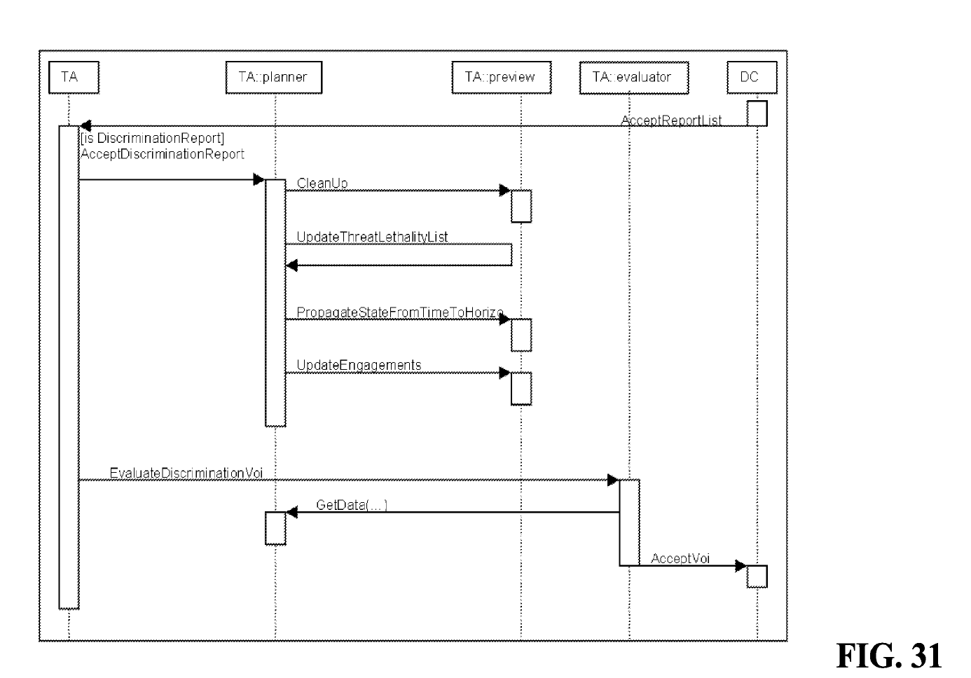

FIG. 31 illustrates a discrimination report sequence 3100. When TA accepts a discrimination report from DC, it passes the report on to the planner. The planner cleans up its internal data structures, updates the threat lethality data, propagates the preview state, and updates the engagements. Next, TA tells the evaluator to evaluate the discrimination VOI. The evaluator gets the data it needs from the planner, computes the discrimination VOI, and sends it to DC.

### Notice Engagement Committed Sequence

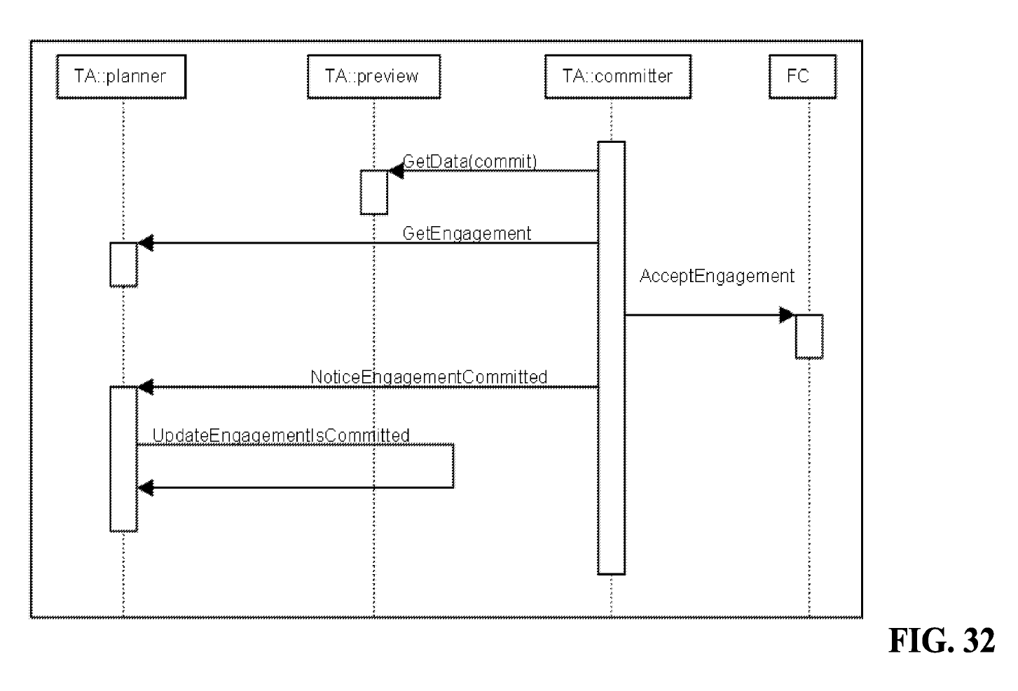

FIG. 32 illustrates a notice engagement committed sequence 3200. The committer monitors the uncommitted engagements in the preview. When the commit time for an engagement arrives, the committer tells FC to accept the engagement and then notifies the planner that the engagement has been committed. The planner updates the engagement's is Committed field.

### Launch Report Sequence

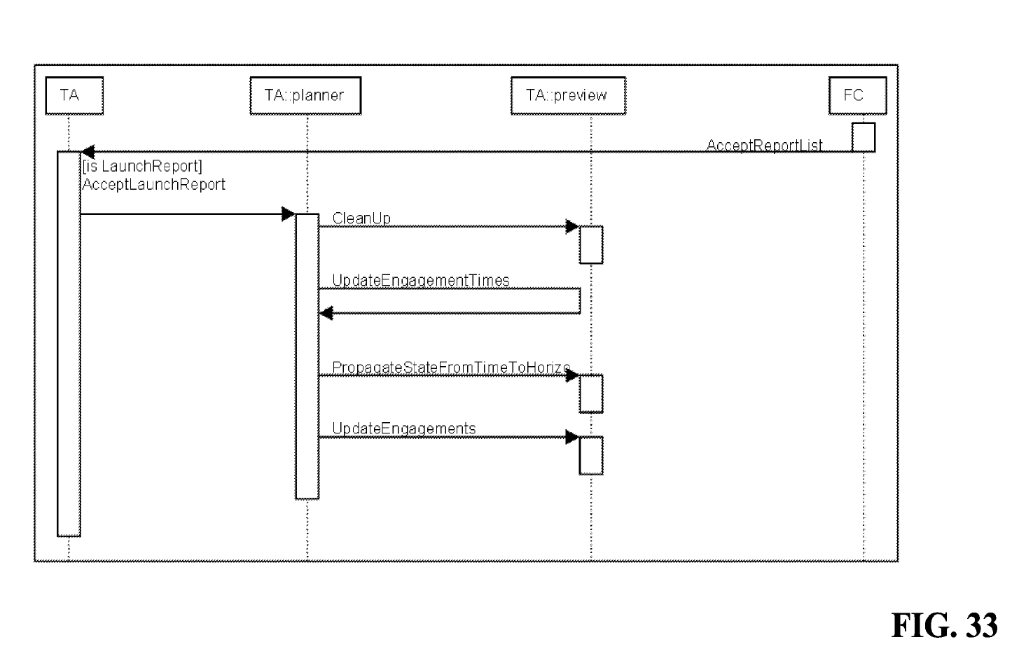

FIG. 33 illustrates a launch report sequence 3300. When TA accepts a launch report from FC, it passes the report on to the planner. The planner cleans up its internal data structures, updates the engagement's times, propagates the preview state, and updates the engagements.

### Kill Assessment Report Sequence

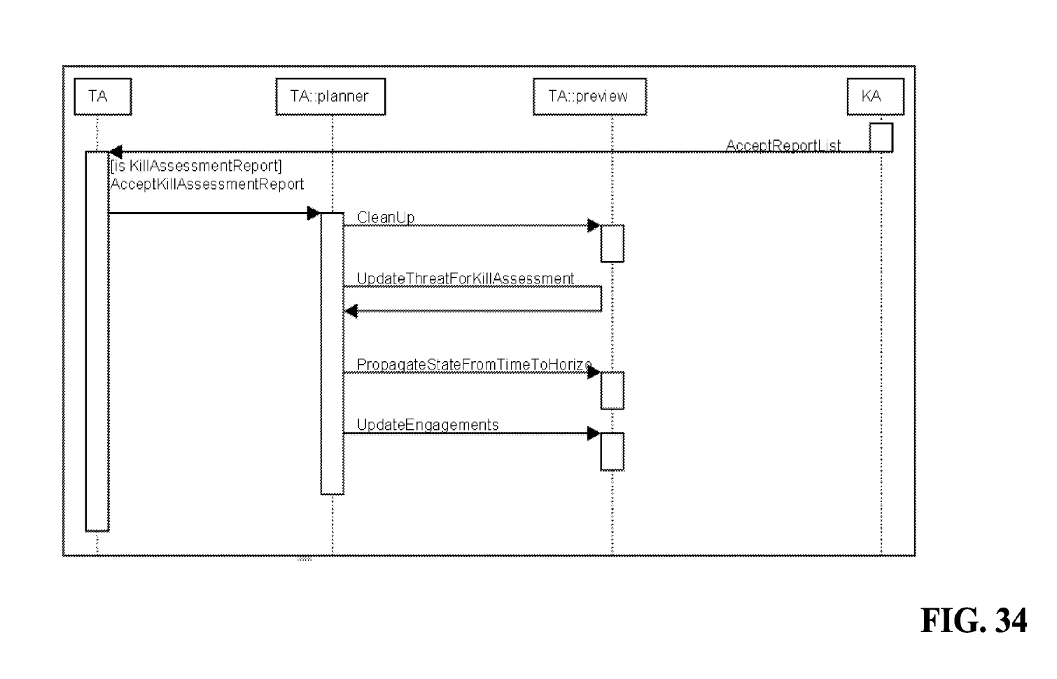

FIG. 34 illustrates a kill assessment report sequence 3400. When TA accepts a kill assessment report from KA, it passes the report on to the planner. The planner cleans up its internal data structures, updates the threat's state, propagates the preview state, and updates the engagements.

### Initializations

TA's planner and preview must be initialized, but not the committer and evaluator.

Initially there are no threats, so planner initialization consists of setting asset values in the asset value list and initializing the threat forecast. The warfighter provides the threat forecast with a conditional tail probability list, as described herein. The defense planner provides possible threat trajectories, which the threat forecast uses to construct the list of pre-threats and associated lists. In particular, the threat forecast invokes the threat evaluation component to initialize the pre-threat value list and the pre-threat asset pair list, and it invokes the battlespace analysis component to initialize the pre-threat shooter pair list.

Since there are no threats yet, preview initialization consists of creating a root node whose battle state has no threat states; a shooter state for each shooter, initialized with the initial shooter inventory; and an asset state for each defended asset, initialized with probability one of survival.

### Updates

Whenever TA receives a report from another component, the planner and the preview update their own data with the report data, and then the planner updates the engagement list, making use of the preview, as in the following pseudocode:

function AcceptReportList(reportList)
{

sort reportList by increasing validity time;
currentTime = latest validity time;
for report in reportList

UpdateData(report);

end
UpdateEngagements(currentTime);

}

The committer always watches the engagement list and commits any engagement whose commit time has arrived.

### Update Data

Every data update begins with a cleanup, according to the following pseudocode:

function Cleanup(currentTime)

{

DeleteUncommittedEngagements;
node = ConstructNode(nullTransition, currentTime);
preview−>InsertNode(node);
preview−>PropagateStateFromRootToTime(currentTime);
DeletePastThreats(currentTime);

}

The current time is the report's validity time. The first step is to delete all uncommitted engagements, from both the preview and the planner. Deleting an engagement from the preview means deleting the commit and assess nodes associated with the engagement. Deleting an engagement from the planner means simply deleting it from the engagement list. The next step is to construct a null node and insert it in the preview at the current time. Assuming that the current time is later than the root node's time, the preview propagates the state of the root node to the new node. Propagating the state of a preview node is described in the next paragraph. The final step is to delete all threats whose ground impact time is earlier than the current time from both the preview and the planner. Deleting a threat from the preview means two things: first, the impact node and every commit and assess node for an engagement against the threat are deleted from the preview; second, the threat state is deleted from the battle state of every remaining node. Deleting a threat from the planner means deleting every engagement against the threat from the engagement list, deleting every threat-shooter pair involving the threat from the threat-shooter pair list, deleting every threat-asset pair involving the threat from the threat-asset pair list, deleting the threat's value from the threat value list, and deleting the threat's lethality from the threat lethality list.

Propagating the state of the preview is described by the following pseudocode:

function PropagateStateFromRootToTime(toTime)

{

parent = root;
lastParent = FindEarliestNodeAtOrAfterTime(toTime);
while (parent is not empty) & (parent ~= lastParent)

child = parent−>child;

if child is not empty

% Copy parent's state to child's state.

child−>state = parent−>state;
% Propagate child's state.
child−>state.PropagateStateOneStep(child−>transition);

end

parent = child;
end

}

In other words, the preview repeatedly copies the state of one node to the state of its child node and then propagates the child's new state by applying its transition, until the node at the desired time has been updated.

Propagating the state one step depends on the node type. If the node is a null node (that is, has a null transition), then the state is not changed. If the node is a commit node, then the state of the shooter that is involved in the engagement that is committed at the node's time is updated in the node's battle state; that involves decrementing the shooter's inventory by the number of interceptors to be launched for the engagement. If the node is an assess node, then the state of the threat that is involved in the engagement that is assessed at the node's time is updated in the node's battle state; that involves reducing its probability of being alive by a factor determined by the engagement's probability of kill. If the node is an impact node, then the states of the assets that are threatened by the threat that is predicted to reach ground impact at the node's time are updated in the node's battle state; that involves reducing their probability of survival by a factor determined by the threat's probability of damage against the asset.

After the cleanup step, data updates depend on the report type.
Threat Evaluation Report
Battlespace Report
Discrimination Report
Launch Report
Kill Assessment Report

Engagement updates depend on the planner approach. This section describes the engagement updates for two new planner approaches, multiple rung integer MMR planner with stochastic search and multiple rung real MMR planner with randomized rounding.

Both approaches work in two steps, as mentioned above. The first step generates an initial solution using a version of the MMR approach. The second step improves the initial solution using a stochastic improvement approach.

Both approaches generate the initial solution using a multiple rung version of MMR. They are multiple rung approaches in the sense that they are not constrained to choose intercept times in the current rung, as in a single rung approach, or to give preference to intercept times in earlier rungs, as in the original THAAD approach.

One approach uses a multiple rung integer version of MMR, and the other uses a multiple rung real version of MMR. An integer MMR approach always increments the number of interceptors assigned to a threat-shooter pair for a particular launch time and intercept time by one, so that the number of interceptors assigned to a threat-shooter pair is always a non-negative integer. A real MMR approach increments the number of interceptors by a predetermined fraction, such as 0.1, so that the number of interceptors assigned to a threat-shooter pair can be a non-integer non-negative real number. Since only whole interceptors can actually be launched, a real MMR approach must be followed by a rounding process. The effect of allowing a fractional increment is to improve the approach's ability to avoid being trapped at a suboptimal solution.

A multiple rung MMR approach works basically like any MMR approach, as described for the prior art, herein. What distinguishes a multiple rung MMR approach is that the intercept time of a candidate assignment for a feasible threat-shooter pair can be in any rung, not just the current rung. However, the intercept time of a candidate assignment is subject to the requirement that it be shoot-look-shoot-compatible with previously assigned intercept times for the same threat-shooter pair. In particular, the intercept time for a candidate is the time with the largest probability of kill, among the feasible intercept times that are shoot-look-shoot-compatible with any previously assigned intercept times for the same threat-shooter pair.

The requirement that a candidate intercept time be shoot-look-shoot-compatible with previously assigned intercept times means that there must be sufficient time before and after the candidate intercept time for shoot-look-shoot with respect to previously assigned intercepts; that is, there is sufficient time between intercepts to allow for kill assessment, for launch preparation, and for interceptor time of flight.

In more detail, a multiple rung MMR approach works in the following way. Initially no interceptors are assigned for any threat-shooter pair except those that are already committed and are now, or soon will be, in flight. The approach generates a pool of candidate assignments, one for each threat-shooter pair with a feasible launch time and intercept time. For each such threat-shooter pair the approach generates the candidate assignment whose intercept time is the time with the largest probability of kill among the assignments that are shoot-look-shoot compatible with previous assignments for that threat-shooter pair. The approach chooses the candidate assignment that would provide the greatest increase in the objective function (when formulated as a maximization problem), and increments the number of interceptors assigned to that threat-shooter pair for the given launch time and intercept time. Next, the approach updates the pool of candidate assignments, subject to the shoot-look-shoot compatibility requirement, shooter inventory constraints, and warfighter-imposed constraints. Then the approach is ready to make another assignment. It iterates this cycle until no more assignments are possible.

Our multiple rung MMR approaches also include candidate assignments against virtual threats, in addition to candidate assignments against actual threats. After the approach has generated or updated the pool of candidate assignments for an iteration, it generates one more candidate against a worst case virtual threat in the context of the assignments made so far. The trajectory of the worst case virtual threat is determined by the planner's forecast component, which contains a probability model of the future of the battle. The virtual threat's launch time and ground impact time are taken to be some unspecified times after the time horizon, the last ground impact time of the actual threats in flight The probability that a virtual threat is initially alive is not 1, as for an actual threat, but is equal to the probability that it would ever be launched, as determined by the forecast. A virtual threat is treated just like an actual threat in the engagement planning process, but no interceptor would ever be committed against a virtual threat. The effect is that interceptors are automatically reserved for the worst contingencies and interceptor inventories are automatically balanced across shooters to avoid gaps in the defense.

The preview plays an important role in the multiple rung MMR approaches, and in the stochastic improvement approaches discussed below. The preview is a probability model of the future of the battle, in terms of the known threats in flight. It is the source of data to support marginal return calculations and objective function evaluations. When one of the approaches selects or modifies a candidate assignment, it records that information in the preview.

Both approaches use a stochastic improvement approach to search a neighborhood of the initial solution for better solutions, and return the best solution found. Both stochastic improvement approaches are easily parallelizable and are anytime approaches, in the sense that they can be stopped at any time and will return the best solution found so far. Thus, both stochastic improvement approaches exploit the available computational and time resources.

The multiple rung integer MMR approach is followed by the stochastic improvement approach that we call stochastic search. Stochastic search starts with an initial solution that has integer-valued assignments of interceptors. The approach repeatedly generates an integer-valued solution that is a perturbation of the current solution, calculating the expected value of the objective function for each solution. If the perturbation has a better expected value of the objective function than the current solution, then the perturbation replaces the current solution; otherwise, the perturbation can still replace the current solution with probability that depends on the difference between the expected values of the objective function for the current and perturbed solutions (this is the Metropolis criterion, also used in simulated annealing). Thus, stochastic search sometimes accepts a perturbation that is worse than the current solution, in the hope of breaking out of a local minimum. Stochastic search returns the best solution found so far when the available time runs out.

Here is pseudocode for stochastic search:

function assignmentMatrix =
ImproveAssignmentMatrixByStochasticLocalSearch ...

(assignmentMatrix)

{

iteration = 0;
marginalReturn = 0.0;
bestMarginalReturn = 0.0;
bestAssignmentMatrix = assignmentMatrix;
potentialCycleSet = assignmentMatrix-

>CreatePotentialCycleSetMultiple;

while (iteration < maxIterations)

cycles = assignmentMatrix-

>DrawRandomCyclesMultiple(potentialCycleSet);

deltaMarginalReturn = assignmentMatrix−> ...

CalculateDeltaMarginalReturnMultiple(cycles);

if ((deltaMarginalReturn > 0.0) | ...

(SatisfiesMetropolisCondition(deltaMarginalReturn))
marginalReturn += deltaMarginalReturn;
assignmentMatrix-

>ModifyAssignmentMatrixForCyclesMultiple(cycles);

if (marginalReturn > bestMarginalReturn)

bestMarginalReturn = marginalReturn;
bestAssignmentMatrix = assignmentMatrix;

end
potentialCycleSet = assignmentMatrix−> ...

CreatePotentialCycleSetMultiple;

end
iteration++;

end
assignmentMatrix = bestAssignmentMatrix;

```
}
function satisfies = SatisfiesMetropolisCondition(deltaMarginal)
  % True if deltaMarginal satisfies Metropolis acceptance criterion.
% Larger T means greater chance of accepting a nonimproving move.
  {
```

satisfies = (rand < min(1, exp(-deltaMarginal/T)));

}

Stochastic search generates a perturbation of the current solution in the following way. Every assignment in the current solution can be described by a triple of positive integers (i, j, k), which stands for engagement k among those assigned to threat i and shooter j. A cycle of assignments is a sequence of four assignments [(i₁, j₁, k₁), (i₂, j₂, k₃), (i₃, j₃, k₃), (i₄, j₄, k₄)] for which

i₁=i₄<i₂=i₃.
j₁=j₂<j₃=j₄.

At least one interceptor is assigned to each of (i₁, j₁, k₁) and (i₃, j₃, k₃).

The first two conditions ensure that the threat-shooter pairs [(i₁, j₁), (i₂, j₂), (i₃, j₃), (i₄, j₄)] index the vertices of a rectangle in a matrix of threat-shooter pairs, with (i₁, j₁) at the upper left, (i₂, j₂) at the lower left, (i₃, j₃) at the lower right, and (i₄, j₄) at the upper right. The third condition ensures that one interceptor assignment can be transferred from (i₁, j₁, k₁) to (i₂, j₂, k₂) and one from (i₃, j₃, k₃) to (i₄, j₄, k₄). Stochastic search draws the number of cycles 711 to select from the uniform distribution over the integers from 1 to a specified maximum number of cycles, and then draws m cycles at random, without replacement, from the set of all possible cycles (or as many as possible up to in). The perturbation of the current solution is obtained by transferring interceptor assignments as determined by the selected cycles.

Each perturbation generated by stochastic search preserves the total number of interceptors assigned to each threat and the total number of interceptors assigned from each shooter, so no constraints are violated; but the number of interceptors assigned to any particular threat-shooter-engagement triple can change, even to zero.

Integer MMR with stochastic search corrects specific deficiencies of the MMR approach. In particular, it allows multiple simultaneous assignments, while MMR always assigns a single interceptor at a time. In addition, the stochastic search approach allows backtracking, unlike MMR.

The multiple rung real MMR approach is followed by the stochastic improvement approach called randomized rounding. Randomized rounding starts with an initial solution that has fractional-valued assignments of interceptors. First, the approach derives a deterministically generated integer solution from the initial fractional solution, in a way that is sure to give a reasonably good integer solution. Then the approach repeatedly derives a randomly generated integer solution from the initial fractional solution and returns the integer solution with the best expected value of the objective function.

Randomized rounding derives a deterministically generated integer solution from the initial fractional solution in the following way. The approach sorts all of the engagements that have been assigned a positive quantity of interceptors by the size of the fractional part of the assignment, largest first. Thus, if two engagements were assigned 3.1 and 2.7 interceptors, respectively, the second engagement would be sorted ahead of the first engagement. Then the approach steps through the engagements in sorted order and rounds the assigned number of interceptors up if no constraints would be violated, and rounds down otherwise.

Randomized rounding derives a randomly generated integer solution from the initial fractional solution in the following way. The approach steps through the engagements that have been assigned a positive quantity of interceptors in a fixed but arbitrary order. For each engagement the approach rounds the assigned number of interceptors up with probability equal to the fractional part of the assigned number if no constraints would be violated, and rounds down otherwise (this is similar to Gibbs sampling, also used in Markov chain Monte Carlo).

Here is pseudocode for randomized rounding:

function bestAssignments = ...

DetermineBestAssignmentsByRandomizedRounding(realAssignments)

{

integerParts = ExtractIntegerParts(realAssignments);
fractionalParts = ExtractFractionalParts(realAssignments);
integerAssignments = GenerateInitialIntegerAssignments ...

(integerParts, fractionalParts);

bestIntegerAssignments = integerAssignments;
bestValue = fObjective(integerAssignments);
for iteration = 1:maxIterations

for i = 1:numThreats

for j = 1:numShooters

for k = 1:numAssignments
integerAssignments(i,j,k) = DrawNewAssignment(i,j,k,

...

integerAssignments, integerParts,

fractionalParts);

end

end

end
value = fObjective(integerAssignments);
if (value > bestValue)

bestIntegerAssignments = integerAssignments;
bestValue = value;

end

end

}
function integerAssignments =
GenerateInitialIntegerAssignments(integerParts, ...

fractionalParts)
sort [fractionalParts, integerParts] by fractionalParts, largest

first;

for integerParts(i,j) in sorted order

if no constraint would be violated

integerAssignments(i,j) = integerParts(i,j) + 1;

else

integerAssignments(i,j) = integerParts(i,j);

end

end

}
function newAssignment = DrawNewAssignment(i,j, integerAssignments, ...

integerParts, fractionalParts)

{

m = integerParts(i,j);
p = fractionalParts(i,j);
if (no constraint would be violated by setting

integerAssignments(i,j) = m+1)

u = standardUniformRandomNumberGenerator−>GenerateNumber;
if (u <= p)

newAssigninent = m + 1;

else

newAssigninent = m;

end

else

newAssignment = m;

end

}

Real MMR with randomized rounding corrects specific deficiencies of the MMR approach. In particular, it allows fractional assignments, while MMR always assigns exactly one interceptor at a time. In addition, the randomized rounding approach allows multiple passes, unlike MMR.

The new invention is most similar to the prior approaches based on MMR, particularly the original THAAD approach, which also modifies an initial MMR solution. It resembles the prior approaches based on exact or approximate dynamic programming only to the extent that it is based on a Markov decision process formulation of the problem. Nevertheless, the differences between even the original THAAD approach and the new invention are substantial.

The new invention uses multiple rung MMR which looks ahead to the time horizon. The prior art (original THAAD approach) uses single rung MMR, applied only to the current rung with an approximate approach suggested in the Alphatech report to reserve interceptors for possible follow-up intercepts on later rungs to compensate for the lack of lookahead.

The new invention uses virtual threats adaptively generated by the forecast which force the approach to reserve interceptors for future threats. The forecast is a probability model of the future of the battle which is conditional on the progress of the battle so far. The prior art uses predetermined interceptor reservation quotas.

The new invention also uses the virtual threats to provide automatic and adaptive balancing of the interceptor inventory over shooters to avoid gaps in the defense. The prior art uses a special balancing approach based on predetermined relative inventory goals.

The new invention uses stochastic improvement approaches designed specifically to compensate for weaknesses of MMR to improve the initial solution generated by MMR. The prior art invokes MMR a second time to generate additional assignments after invoking the balancing approach.

The new invention is easily parallelizable because independent copies of the stochastic improvement approaches can be run on multiple processors simultaneously by simply using a different random number seed on each processor. No prior approach has this property.

The new invention is an anytime approach; that is, it can be stopped at any time and will return the best solution found so far. The prior approaches must run to completion.

### Advantages

The disclosed approaches always generate a solution at least as good as MMR, because it uses the MMR solution as an initial solution and then applies an improvement step.

The disclosed approaches makes better use of its interceptors than the original THAAD approach because the multiple rung MMR approach allows the disclosed approaches to look ahead to the time horizon. This look-ahead is important because during a missile defense battle interceptors are effectively a non-renewable resource.

The worst case virtual threats provided by the disclosed approaches' forecast provide a more adaptive means for reserving interceptors for future threats and for balancing interceptor inventories across shooters than the original THAAD approach's predetermined goals and thresholds.

The disclosed approaches' easily parallelizable stochastic improvement approaches make better use of the available computing resources than the various exact and approximate dynamic programming approaches.

The anytime character of the disclosed approaches' stochastic improvement approaches allows the disclosed approaches to make better use of the available time than the various exact and approximate dynamic programming approaches. In fact, for this reason, the disclosed approaches incorporate a real time approach, even for heavy loads, unlike the dynamic programming approaches.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The teachings herein may be incorporated into (e.g., implemented within or performed by) a variety of apparatuses (e.g., devices). Accordingly, one or more aspects taught herein may be incorporated into a computer (e.g., a laptop), a portable communication device, an image processing system (e.g., a radar or photo image processing system), a portable computing device (e.g., a personal data assistant), a global positioning system device, or any other suitable device that is configured to perform image processing.

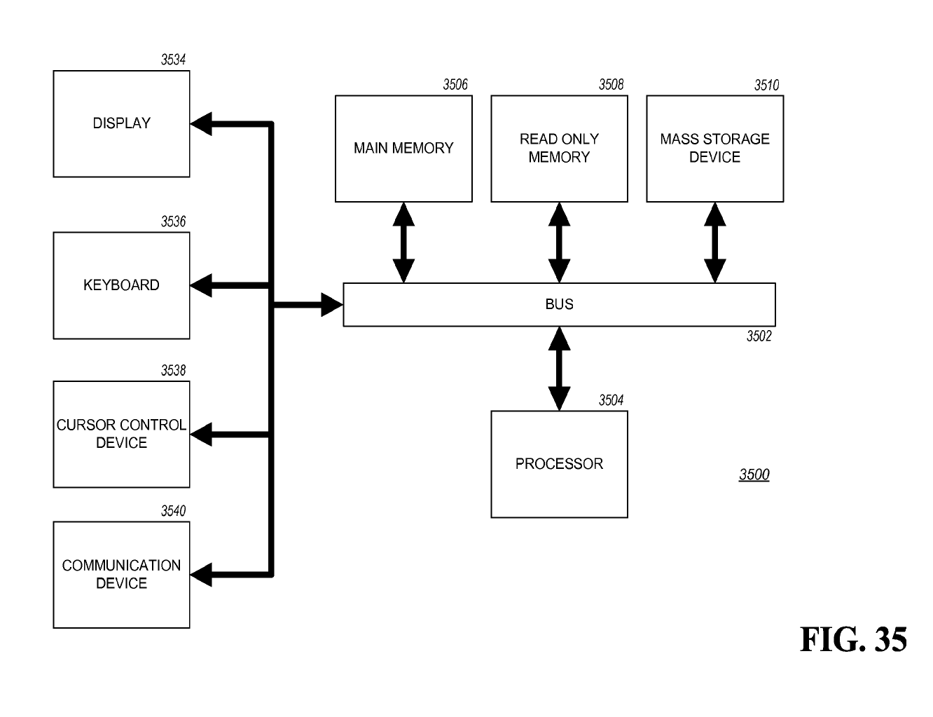

FIG. 35 illustrates an example of a computer system 3500 in which certain features of the exemplary real-time object detection and interception system may be implemented. Computer system 3500 includes a bus 3502 for communicating information between the components in computer system 3500, and a processor 3504 coupled with bus 3502 for executing software code, or instructions, and processing information. Computer system 3500 further comprises a main memory 3506, which may be implemented using random access memory (RAM) and/or other random memory storage device, coupled to bus 3502 for storing information and instructions to be executed by processor 3504. Main memory 3506 also may be used for storing temporary variables or other intermediate information during execution of instructions by processor 3504. Computer system 3500 also includes a read only memory (ROM) 3508 and/or other static storage device coupled to bus 3502 for storing static information and instructions for processor 3504.

Further, a mass storage device 3510, such as a magnetic disk drive and/or a optical disk drive, may be coupled to computer system 3500 for storing information and instructions. Computer system 3500 can also be coupled via bus 3502 to a display device 3534, such as a cathode ray tube (CRT) or a liquid crystal display (LCD), for displaying information to a user so that, for example, graphical or textual information may be presented to the user on display device 3534. Typically, an alphanumeric input device 3536, including alphanumeric and other keys, is coupled to bus 3502 for communicating information and/or user commands to processor 3504. Another type of user input device shown in the figure is a cursor control device 3538, such as a conventional mouse, touch mouse, trackball, track pad or other type of cursor direction key for communicating direction information and command selection to processor 3504 and for controlling movement of a cursor on display 3534. Various types of input devices, including, but not limited to, the input devices described herein unless otherwise noted, allow the user to provide command or input to computer system 3500. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 3500 may optionally include such devices as a video camera, speakers, a sound card, or many other conventional computer peripheral options.

A communication device 3540 is also coupled to bus 3502 for accessing other computer systems or networked devices, as described below. Communication device 3540 may include a modem, a network interface card, or other well-known interface devices, such as those used for interfacing with Ethernet, Token-ring, or other types of networks. In this manner, computer system 3500 may be coupled to a number of other computer systems.

The various illustrative logical blocks, modules, and circuits described in connection with the aspects disclosed herein may be implemented within or performed by an integrated circuit (“IC”). The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects shown herein but is to be accorded the widest scope consistent with the principles and novel features disclosed herein.

What is claimed is:

1. A system for managing battlespace resources comprising:
determining a probability of interception by an interceptor of an object to be intercepted; and
allocating a set of resources based on the probability.
